(19) United States
(12) Patent Application Publication
(10) Pub. No.: US 2013/0230173 A1
(43) Pub. Date: Sep. 5, 2013

(54) COMMUNICATION APPARATUS FOR TRANSMITTING OR RECEIVING A SIGNAL INCLUDING PREDETERMIND INFORMATION

(71) Applicant: SANYO ELECTRIC CO., LTD., Osaka (JP)

(72) Inventor: Yoshihiro HORI, Gifu-shi (JP)

(73) Assignee: SANYO ELECTRIC CO., LTD., Osaka (JP)

(21) Appl. No.: 13/853,763

(22) Filed: Mar. 29, 2013

Related U.S. Application Data
(63) Continuation of application No. PCT/JP2011/007128, filed on Dec. 20, 2011.

(30) Foreign Application Priority Data
Jan. 25, 2011 (JP) 2011-013486
Jan. 31, 2011 (JP) 2011-019072

(51) Int. Cl. H04L 9/08

(52) U.S. Cl. CPC H04L 9/0819
USPC 380/281; 380/279

(57) ABSTRACT

A storage stores a common key table containing a plurality of kinds of common keys usable for the communications with other communication apparatuses within the same system, its own identification information, and an update key associated with the identification information. The transmitter transmits the identification information to a system management apparatus for managing the common key table used in the system, the identification information on the communication apparatuses within the system, and the update key associated with the identification information. An acquiring unit acquires, from the system management apparatus that has received the identification information, a common key table for use in update (updating common key table) encrypted using the update key associated with the identification information. A decryption unit decrypts the encrypted updating common key table by use of the update key stored in the storage.

### BACKGROUND OF THE INVENTION

1. Field of the Invention

The present invention relates to a communication technology, and it particularly relates to a communication apparatus that transmits and receives signals containing predetermined information.

2. Description of the Related Art

There are two main types of radio communication for automobiles; a road-to-vehicle communication and a vehicle-to-vehicle (inter-vehicular) communication. Note also that the inter-vehicular communication includes a vehicle-to-road communication. Either communication can be used to prevent collision of vehicles on a sudden encounter at an intersection and prevent rear-end collisions due to the congestion around corners, for instance. Current position information is detected in real time by GPS (Global Positioning System) or the like and the position information is exchanged between their in-vehicle units, thereby making it possible to prevent the collision of vehicles at the intersection. In the road-to-vehicle communication, roadside units are installed at an intersection and on road sides, so that the aforementioned drive support information is transmitted to the in-vehicle units from the road sides.

The wireless communications are more susceptible to an interception of communication and an unauthorized intervention by a fake third party than the wired communications. It is therefore more important to countermeasure such interception and intervention in the wireless communications than in the wired communications. In order to ensure the secrecy of communication content, it is effective to encrypt the communication data. There are two main encryption schemes; a public key encryption scheme and a common key encryption scheme. The former has a higher security than the latter but has more data amount than the latter. Besides, the former has a larger processing load than the latter and therefore the overall implementation cost is higher than the latter. In other words, the public key encryption scheme and the common key encryption scheme are in a trade-off relation with each other.

When messages are to be sent in the road-to-vehicle communication and the inter-vehicular communication where broadcasting is assumed, it is plausible to use the common key encryption scheme because key data cannot be exchanged and the real-timeliness needs to be emphasized. In this case, all the common keys are basically shared by the in-vehicle units and the roadside units operated on the same system. If, however, an encryption key is leaked from any one of the in-vehicle units or roadside units, the security level of the system as a whole will be significantly reduced. In the light of the foregoing circumstances, a method has been under investigation where an encryption table including a plurality of encryption keys are prepared, an encryption key used at the time of data transmission is selected randomly, and these encryption tables are updated periodically so as to enhance the security.

### SUMMARY OF THE INVENTION

In order to resolve the above-described problems, a communication apparatus according to one embodiment of the present invention includes: a storage configured to store a common key table, its own identification information, and an update key associated with the identification information, the common key table containing a plurality of kinds of common keys usable for a communication with another communication apparatus within a single system; a transmitter configured to transmit the identification information to a system management apparatus for managing the common key table, used in the system, the identification information on the communication apparatus within the system, and the update key associated with the identification information thereon; an acquiring unit configured to acquire, from the system management apparatus that has received the identification information, a common key table for use in update (updating common key table) encrypted using the update key associated with the identification information; and a decryption unit configured to decrypt the encrypted updating common key table by use of the update key stored in the storage.

Another embodiment of the present invention relates also to a communication apparatus. The communication apparatus includes: a security processing unit configured to decrypt received data; a storage configured to store a common key table, registration information on the security processing unit, and a registration key associated with the registration information, the common key table containing a plurality of kinds of common keys usable for a communication with another communication apparatus within a single system; a transmitter configured to transmit the registration information to a system management apparatus for managing the common key table used within the system, the registration information on the security processing of the communication system within the system, and the registration key associated with the registration information; and an acquiring unit configured to acquire, from the system management apparatus that has received the registration information, a common key table for use in update (updating common key table) encrypted using the registration key associated with the registration information. The security processing unit decrypts the encrypted updating common table by use of the registration key stored in the storage.

Still another embodiment of the present invention relates also to a communication apparatus. The communication apparatus includes: a storage configured to store a common key table, which contains a plurality of kinds of common keys usable for a communication with another communication apparatus within a single system, and an update master key commonly used in the system; an acquiring unit configured to acquire a table updating key, used to encrypt a common key table for use in update (updating common key table), and the updating common key table encrypted using the table updating key, which are transmitted from a system management apparatus for managing the common key table, and configured to acquire identification information, on an communication apparatus, transmitted from said communication apparatus to be updated; and an encryption unit configured to encrypt the table updating key using the update master key and the identification information on said communication apparatus; and a broadcasting unit configured to broadcast the table updating key encrypted by the encryption unit and the encrypted updating common key table.

Still another embodiment of the present invention relates also to a communication apparatus. The communication apparatus includes: a storage configured to store a common key table, which contains a plurality of kinds of common keys usable for a communication with another communication apparatus within a single system, an update master key commonly used in the system, and its own identification information; a broadcasting unit configured to broadcast the identification information; an acquiring unit configured to acquire, from a communication apparatus that has received the identification information, a table updating key, encrypted using the identification information and the update master key owned by said communication apparatus, and a common key table for use in update (updating common key table) encrypted using the table updating key; and a decryption unit configured to decrypt the encrypted table updating key by use of the identification information and the update master key stored in the storage and configured to decrypt the encrypted updating common key table by use of the decrypted table updating key.

Still another embodiment of the present invention relates also to a communication apparatus. The communication apparatus includes: a storage configured to store a key table containing a plurality of communication keys usable for a communication with another communication apparatus within a single system; an acquiring unit configured to acquire identification information on a communication key, which is to be determined unusable, transmitted from a system operations management apparatus for managing use and operation of the key table; and a broadcasting unit configured to broadcast the identification information on the communication key, which is to be determined unusable, acquired by the acquiring unit.

Still another embodiment of the present invention relates also to a communication apparatus. The communication apparatus includes: a storage configured to store a key table containing a plurality of communication keys usable for a communication with another communication apparatus within a single system; an acquiring unit configured to acquire identification information on a communication key, which is to be determined unusable, transmitted from the other communication apparatus; and an update unit configured to invalidate said communication key contained in the key table based on the identification information on said communication key, which is to be determined unusable, acquired by the acquiring unit.

Still another embodiment of the present invention relates also to a communication apparatus. The communication apparatus includes: a storage configured to store a common key table, which contains a plurality of common keys usable for a communication with another communication apparatus within a single system, and an update master key commonly used in the system; an acquiring unit configured to acquire a table updating key, used to encrypt a common key table with a negative flag indicating a common key to be invalidated, and an updating common key table encrypted using the table updating key, which are transmitted from a system management apparatus for managing the common key table, and configured to acquire identification information, on an communication apparatus, transmitted from said communication apparatus to be updated; and an encryption unit configured to encrypt the table updating key using the update master key and the identification information on said communication apparatus; and a broadcasting unit configured to broadcast the table updating key encrypted by the encryption unit and the encrypted updating common key table.

Still another embodiment of the present invention relates also to a communication apparatus. The communication apparatus includes: a storage configured to store a common key table, which contains a plurality of common keys usable for a communication with another communication apparatus within a single system, an update master key commonly used in the system, and its own identification information; a broadcasting unit configured to broadcast the identification information; an acquiring unit configured to acquire, from a communication apparatus that has received the identification information, a table updating key, encrypted using the identification information and the update master key owned by said communication apparatus, and a common key table, with a negative flag, which is encrypted using the table updating key; a decryption unit configured to decrypt the encrypted table updating key by use of the identification information and the update master key stored in the storage and configured to decrypt the encrypted common key table with the negative flag by use of the decrypted table updating key.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a structure of a communication system according to an exemplary embodiment of the present invention;

FIG. 2 shows a structure of a base station apparatus;

FIG. 3 shows a format of MAC frame contained in a packet signal defined in a communication system;

FIGS. 4A and 4B each shows an exemplary data structure of messages constituting a security frame;

FIG. 5 shows a data structure of message type;

FIG. 6 shows a data structure of key ID;

FIG. 7 shows exemplary common key tables to be shared by each apparatus or device on a communication system;

FIG. 8 is a diagram to explain the switching of transmitting tables;

FIG. 9 shows a structure of a terminal apparatus installed in a vehicle;

FIG. 10 is a diagram to explain the transmission of messages from a roadside unit (base station apparatus) to an in-vehicle unit (terminal apparatus) in a road-to-vehicle communication;

FIG. 11 is a diagram to explain how a common key table is rewritten or renewed;

FIG. 12 shows a format of a common key table;

FIG. 13 is a diagram to explain the updating of a common key table from a roadside unit (base station apparatus) to an in-vehicle unit (terminal apparatus) in a road-to-vehicle communication;

FIG. 14 is a diagram to explain a modification to the updating of a common key table from a roadside unit (base station apparatus) to an in-vehicle unit (terminal apparatus) in a road-to-vehicle communication;

FIG. 15 shows a format of a common key table with a negative flag;

FIG. 16 is a diagram to explain how en expired key is rewritten or renewed;

FIG. 17 is a diagram to explain the expiration of a common key from a roadside unit (base station apparatus) to an in-vehicle unit (terminal apparatus) in a road-to-vehicle communication;

FIG. 18 is a diagram to explain the updating of a common key table with a negative flag from a roadside unit (base station apparatus) to an in-vehicle unit (terminal apparatus) in a road-to-vehicle communication;

FIG. 19 is a diagram to explain the rewriting of a common key table according to a modification;

FIGS. 20A and 20B are diagrams to explain a procedure, for updating a common key table, according to a modification;

FIG. 21 shows a format of a common key table according to a modification;

FIG. 22 shows a first format of a security frame according to a modification;

FIG. 23 shows a second format of a security frame according to a modification;

FIG. 24 is a diagram to explain a method of making use of a common key table according to a modification; and

FIG. 25 shows a modification of the first format of the security frame shown in FIG. 22.

### DETAILED DESCRIPTION OF THE INVENTION

The invention will now be described by reference to the preferred embodiments. This does not intend to limit the scope of the present invention, but to exemplify the invention.

The present invention will be outlined before it is explained in detail. Exemplary embodiments of the present invention relate to a communication system such as ITS (Intelligent Transport System). Here, the communication system such as ITS uses both a road-to-vehicle communication carried out to provide information from a base station apparatus installed in an intersection, on a road side and the like to vehicles and an inter-vehicular communication carried out to provide information from a terminal apparatus mounted in a vehicle to another vehicle.

Use of wireless LAN compliant with IEEE 802.11 and the like in ITS has been under consideration. An access control function called CSMA/CA (Carrier-Sense Multiple Access with Collision Avoidance) is used in such wireless LAN. Thus, in this wireless LAN, the same radio channel is shared by the base station apparatus and a plurality of terminal apparatuses. In such a scheme as CSMA, a packet signal is transmitted by broadcast after it has been verified by carrier sense that other packet signals are not transmitted. Note that the transmission of packet signals by broadcast will hereinafter be called “broadcasting”, “being broadcast” or “by broadcast” also.

As the inter-vehicular communication, a terminal apparatus transmits, by broadcast, a packet signal in which vehicle information indicating the traveling speed, position and so forth of a vehicle that installs the terminal apparatus is stored. A terminal apparatus, which receives said packet signal, recognizes the approach or the like of the vehicle based on the information stored in said packet signal. As the road-to-vehicle communication, the base station apparatus broadcasts a packet signal in which intersection information and traffic congestion information are stored.

The intersection information includes information on conditions at an intersection such as the position of the intersection, images captured of the intersection, where the base station apparatus is installed, and positional information on vehicles at or near the intersection. A terminal apparatus displays the intersection information on a monitor. Also, the terminal apparatus may recognize the conditions at the intersection based on the intersection information, and may broadcast audio messages to a user for the purpose of preventing collision between vehicles, bicycles, and pedestrians due to a right turn or a left turn at a sudden encounter at the intersection. The traffic congestion information includes information concerning the congestion situation in a road, where the base station apparatus is installed, and the information concerning road repairing and accidents that have happened. Based on the traffic congestion information, the terminal apparatus conveys to the user how much the road ahead may be congested. Also, the terminal apparatus may present any possible detour to the user.

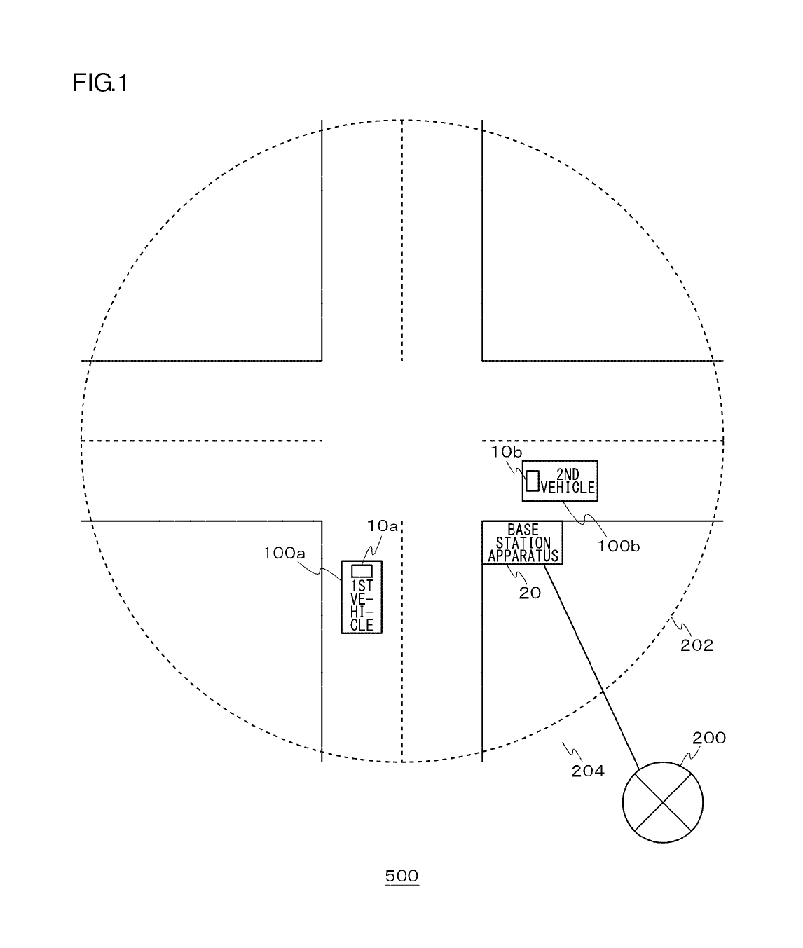

FIG. 1 shows a structure of a communication system 500 according to an exemplary embodiment of the present invention. FIG. 1 corresponds to a case where an intersection is viewed from above. The communication system 500 includes a base station apparatus 20, a terminal apparatus 10a installed in a first vehicle 100a, and a terminal apparatus 10b installed in a second vehicle 100b. An area 202 indicates a zone or area within which the radio waves transmitted from the base station apparatus 20 is reachable, and an almost-unreachable area 204 indicates a zone or area where the radio waves transmitted from the base station apparatus 20 is almost unreachable. The upper side of FIG. 1 corresponds to the “north”, and the first vehicle 100a is advancing from the “south” to the “north”, while the second vehicle 100b is advancing from the “east” to the “west”. The base station apparatus 20 can communicate with a road-to-vehicle service company terminal apparatus (described later) via an external network 200.

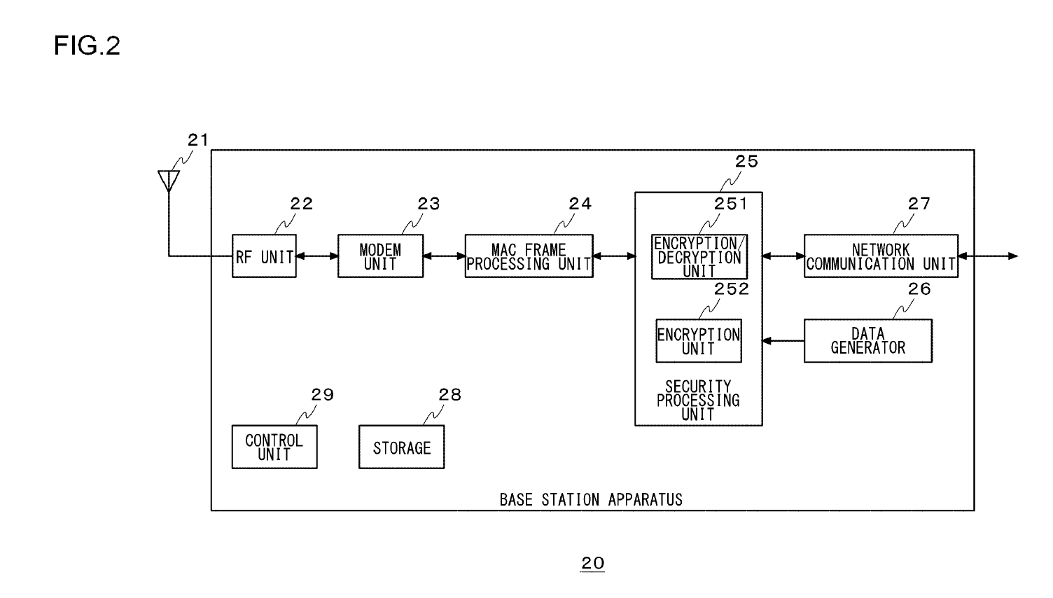

FIG. 2 shows a structure of the base station apparatus 20. The base station apparatus 20 includes an antenna 21, an RF unit 22, a modem unit 23, a MAC frame processing unit 24, a security processing unit 25, a data generator 26, a network communication unit 27, a storage 28, and a control unit 29. The security processing unit 25 includes an encryption/decryption unit 251 and an encryption unit 252.

The MAC frame processing unit 24, the security processing unit 25, the data generator 26, the network communication unit 27, the storage 28 and the control unit 29 may be configured hardwarewise by elements such as any given processor, memory and other LSIs and/or may be configured softwarewise by memory-loaded programs or the like. Depicted herein are functional blocks implemented by cooperation of hardware and software. Therefore, it will be obvious to those skilled in the art that theses functional blocks may be implemented by a variety of manners including hardware only, software only or a combination of both.

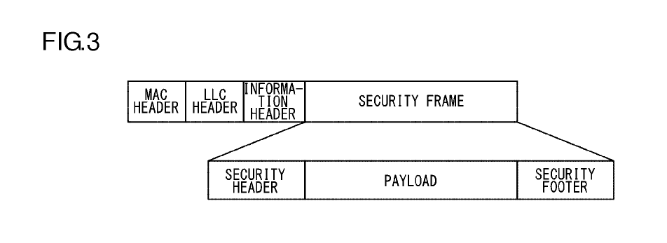

FIG. 3 shows a format of MAC frame contained in a packet signal defined in the communication system 500. Starting from the beginning, the MAC frame is constituted by “MAC header”, “LLC header”, “information header”, and “security frame” in this order. Information concerning data communication control is stored in the “MAC header”, the “LLC header”, and the “information header”, and the respective headers correspond to the respective layers of communication layer. Each field length is defined as follows, for instance. The “MAC header” is of 30 bytes, the “LLC header” 8 bytes, and the “information header” 12 bytes. Starting from the beginning, the security frame is comprised of “security header”, “payload”, and “security footer”, in this order.

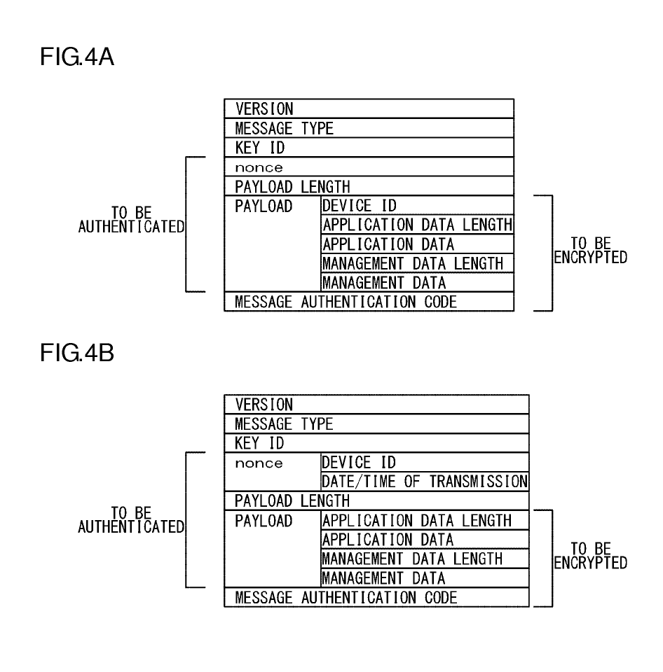

FIGS. 4A and 4B each shows an exemplary data structure of messages constituting a security frame. As the security header, the data structure of messages shown in FIG. 4A includes “version”, “message type”, “key ID”, “nonce”, and “payload length”. As the payload, it includes “device ID”, “application data length”, “application data”, “management data length” and “management data”. As the security footer, it includes “message authentication code”.

Primarily, “payload” is data to be authenticated and encrypted. However, “nonce” and “payload length” are also counted as and contained in the to-be-authenticated data for the purpose of enhancing the reliability. More specifically, “nonce” and “payload length” are assigned to a leading block and “payload” is assigned to a second block and the subsequent blocks, all of which constitute a block sequence to be authenticated, and then a message authentication code will be obtained for this block sequence. Here, “block” is a unit of computing the message authentication code. “Nonce” is data by which to intend to make the “message authentication code” different per signal even though the “payloads” are identical, so that a unique value is set to the nonce for each message. “Payload length” indicates the data length of “payload” and improves the reliability against the falsification of data including the insertion and/or deletion of data, for instance. Similarly, “message authentication code” is also counted as and contained in the to-be-encrypted data.

In this data structure, “nonce”, “payload length”, “device ID”, “application data length”, “application data”, “management data length”, and “management data” are to be authenticated. Also, “device ID”, “application data length”, “application data”, “management data length”, “management data”, and “message authentication code” are to be encrypted.

As the security header, the data structure of messages shown in FIG. 4B includes “version”, “message type”, “key ID”, and “nonce”. “Nonce” includes “device ID” and “date/time of transmission”. As the payload, it includes “application data length”, “application data”, “management data”, and “management data”. As the security footer, it includes “message authentication code”. In this data structure, “nonce”, “payload length”, “application data length”, “application data”, “management data length”, and “management data” are to be authenticated. Also, “application data length”, “application data”, “management data length”, “management data”, and “message authentication code” are to be encrypted. In both cases, those which are to be encrypted are the payload and the message authentication code.

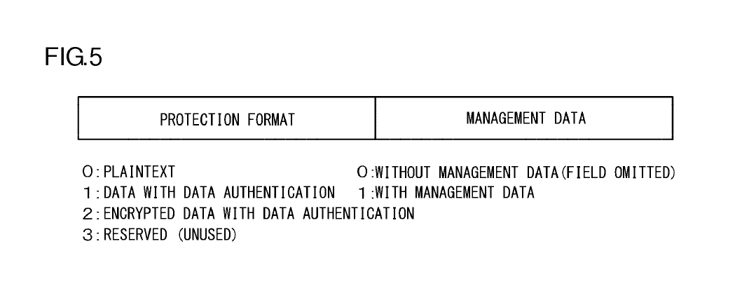

FIG. 5 shows a data structure of message type. The message type is constructed of “protection format” and “management data”. Any one of “0”, “1”, “2”, and “3” is set to the “protection format”. Here, “0” indicates that a message is a plain text; no message authentication code is appended and the message is not encrypted. “1” indicates that a message is data with data authentication. For example, AES (Advanced Encryption Standard)-CBC (Cipher Authentication Code)-MAC (Message Authentication Code) scheme may be used for the data authentication. In such a case, MAC generated by carrying out an AES-CBC mode encryption process is appended to the message. “2” indicates that a message is encrypted data with data authentication. For example, AES-CCM (Counter with CBC-MAC) scheme may be used for the data authentication. MAC generated by carrying out an AES-CCM mode encryption process is appended to the message and, at the same time, the message is encrypted using an AES-Counter mode. “3” indicates that a space is reserved.

Either “0” or “1” is set to the “management data”. Here, “0” indicates that the message does not contain management data. In this case, a management data field, namely the management data length and the management data, is not set. In the inter-vehicular communication, “0” is generally set. “1” indicates that the message contains the management data field. Where “0” is set, a change may be made such that no application data length is set for the purpose of eliminating the redundancy. In FIG. 4A, the data contained in the payload are the device ID and the application data of fixed lengths. Thus the application data can be identified without setting the application data length. In FIG. 4B, the data contained in the payload is the application data only, which is more obvious than the case of FIG. 4A.

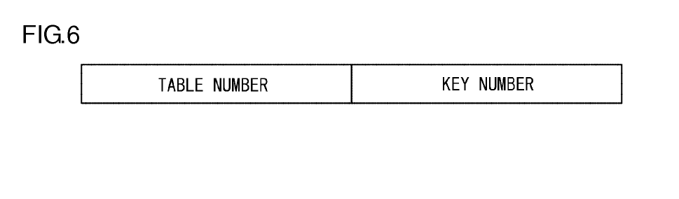

FIG. 6 shows a data structure of key ID. The key ID is constructed of “table number” and “key number”. The identification number of a common key table is set to the “table number”. The identification number of a key in the common key table is set to the “key number”. At the time of transmission of packet signal, a key randomly selected from a predetermined common key table for use with transmission is used as a communication key. Thus the number of a common key table for use with transmission is set to the table number, whereas a random number is set to the key number.

“Device ID” is constructed of “type” and “individual information”. Information by which to identify whether an applicable device or vehicle is a roadside unit, an emergency vehicle or an ordinary vehicle is set to the “type”. A unique value to identify each device is set to the “individual information”.

A unique value is set to the “nonce” in FIG. 4A for each message. The unique value set thereto may be a random number. Instead of the unique value, the device ID and the date/time of transmission are set to the “nonce” in FIG. 4B. This is based on a design concept in which each message can be uniquely identified if the device ID and the date/time of transmission are identified.

The aforementioned intersection information, traffic congestion information, vehicle information and so forth are set to the “application data”. Maintenance information on the security, such as the updating of a key, and so forth are set to the “management data”.

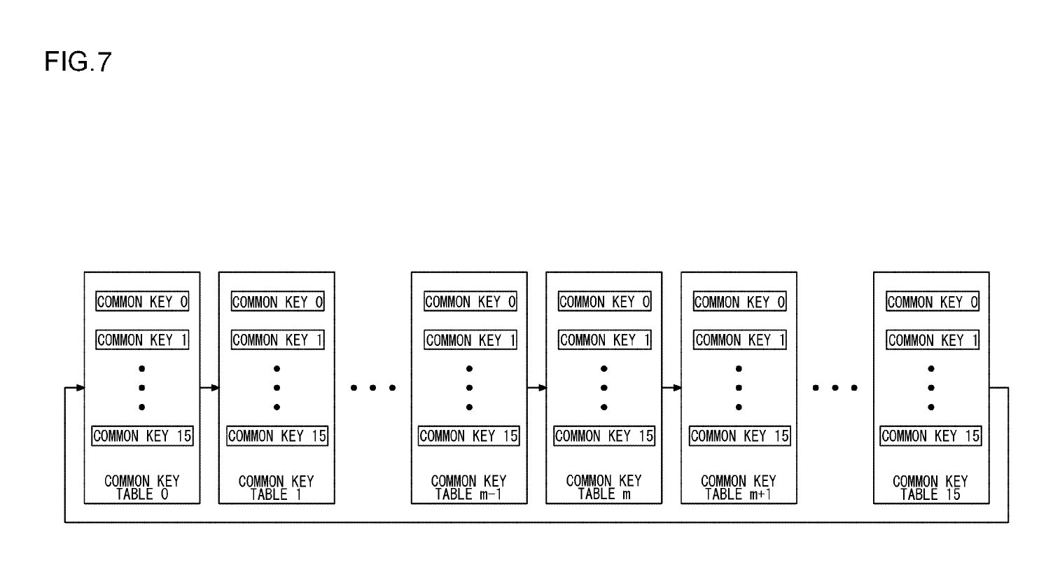

FIG. 7 shows exemplary common key tables to be shared by each apparatus or device on the communication system 500. A plurality of common key tables each including a plurality of kinds of common keys are shared. Each of a plurality of common key tables includes a plurality of common keys of difference values. The present exemplary embodiment shows an example where 16 kinds of common key tables each including 16 kinds of common keys are shared. In other words, the present exemplary embodiment shows an example where 256 common keys are shared. Note that the number of common keys included in each common key table needs not to be identical and may differ.

A single common key table for use with the transmission (hereinafter referred to as “transmitting table” also) is selected from among a plurality of common key tables. The transmitting table is switched among the plurality of common key tables on a periodic basis of 6 months or one or two years, for instance. In the example of FIG. 7, the common key table is switched in the order of “common key table 0”→“common key table 1”→ . . . →“common key table 15” and then the common key table returns to the initial common key table 0 when it reaches the last common key table 15. A common key used in the transmitting table is selected at random.

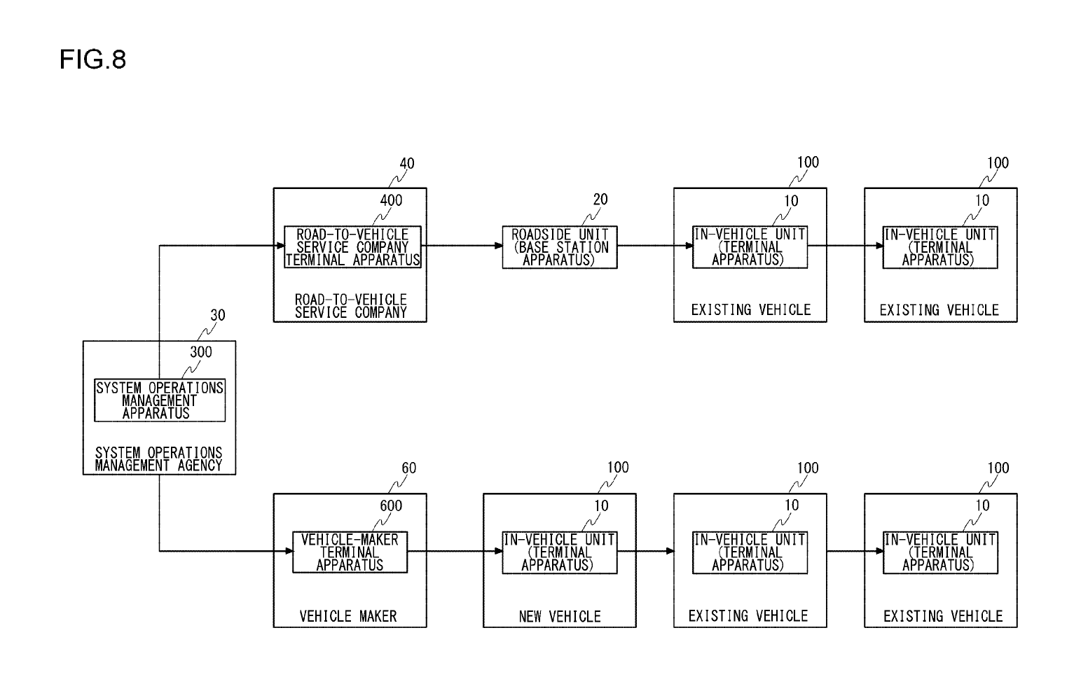

FIG. 8 is a diagram to explain the switching of transmitting tables. In the present exemplary embodiment, the timing with which the transmitting tables are switched is determined by a system operations management agency 30. A system operations management apparatus 300 of the system operations management agency 30 instructs a road-to-vehicle service company terminal apparatus 400 of a road-to-vehicle service company 40 and a vehicle-maker terminal apparatus 600 of a vehicle-maker 60 to switch the transmitting tables. The present exemplary embodiment shows an example where the switching of the transmitting tables is instructed from the system operations management apparatus 300 to the road-to-vehicle service company terminal apparatus 400 and the vehicle-maker terminal apparatus 600 via an external network 200 such as the Internet or dedicated line. Note that the system operations management agency 30 may instruct the road-to-vehicle service company 40 and the vehicle maker 60 using other communication means (e.g., by postal mail).

The road-to-vehicle service company terminal apparatus 400 transmits to the roadside unit (base station apparatus 20) a message containing a common key included in a transmitting table after the switching. Upon receiving the message, the roadside unit sets the common key table including said common key to a new transmitting table. The roadside unit broadcasts the message using the common key included in the common key table newly set to the transmitting table. Upon receiving the message, an in-vehicle unit (terminal apparatus 10) of an existing vehicle 100 sets the common key table including said common key to a new transmitting table. Then the in-vehicle unit broadcasts the message containing the common key included in a common key table newly set to the transmitting table. Upon receiving the message, an in-vehicle unit of another existing vehicle 100 sets the common key table including said common key to a new transmitting table. This process will be repeated.

Also, the vehicle-maker terminal apparatus 600 instructs an in-vehicle (terminal apparatus 10) of a new vehicle 100 to set a common key table, specified by the road-to-vehicle service company terminal apparatus 400, to the transmitting table. The in-vehicle unit broadcasts a message containing a common key (communication key) included in the common key table set to the transmitting table. Upon receiving the message, the in-vehicle unit of the existing vehicle 100 sets the common key table including said common key to a new transmitting table. Then the in-vehicle unit broadcasts the message containing the common key included in a common key table newly set to the transmitting table. Upon receiving the message, an in-vehicle unit of another existing vehicle 100 sets the common key table including said common key to a new transmitting table. This process will be repeated.

By carrying out the above-described processes, the transmitting tables in each device of the communication system 500 are switched in a propagating manner, namely, switched in succession. Instead of such a propagating system, the transmitting tables may be switched according to a scheduling program that has been set beforehand in each device. However, this alternative method may be employed on the condition that (1) a watch or time measuring device is provided, (2) the watch or time measuring device is accurate, and (3) the watch of a roadside unit and the watch of an in-vehicle unit are synchronized with each other. Thus, the both methods may be used in combination to complement each other. Though the road-to-vehicle service company terminal apparatus 400, the vehicle-maker terminal apparatus 600, and the roadside unit are each provided in a single piece in FIG. 8, each of them are actually provided in a plurality.

Now refer back to FIG. 2. The RF unit 22 receives, through the antenna 21, packet signals transmitted from terminal apparatuses and the other base station apparatuses, as a receiving processing. In the present exemplary embodiment, the RF unit 22 receives, from a terminal apparatus 10 for which the common key table is to be updated, a packet signal in which the device ID of said terminal apparatus 10 is stored.

The RF unit 22 performs a frequency conversion on the received packet signal of a radiofrequency and thereby generates a packet signal of baseband. The RF unit 22 outputs the baseband packet signal to the modem unit 23. Generally, a baseband packet signal is formed of an in-phase component and a quadrature component, and therefore it should be represented by two signal lines. However, it is represented by a single signal line here to make the illustration clearer for understanding. The RF unit 22 includes an LNA (Low Noise Amplifier), a mixer, an AGC (Automatic Gain Control) unit, an A/D converter, and so forth, all of which are not-shown components constituting a receiving system.

The RF unit 22 transmits the thus generated packet signal from the base station apparatus 20, as a transmission processing. In the present exemplary embodiment, the RF unit 22 broadcasts a packet signal, in which a table updating key encrypted by the security processing unit 25 (hereinafter referred to as “encrypted table updating key” also) is stored, and a packet signal, in which an update common key table in an encrypted state (hereinafter referred to as “encrypted update common key table” also) is stored. The timing with which the encrypted table updating key is broadcast and the timing with which the encrypted update common key table is broadcast may differ from each other or may be identical. If the timings are different, the encrypted table updating key may be broadcast before or after the encrypted update common key table is broadcast.

The RF unit 22 performs a frequency conversion on the baseband packet signal inputted from the modem unit 23 and thereby generates a radiofrequency packet signal. The RF unit 22 transmits, through the antenna 21, the radiofrequency packet signal in a road-to-vehicle transmission period. The RF unit 22 also includes a PA (Power Amplifier), a mixer, a D-A converter, and so forth, all of which are not-shown components constituting a transmission system.

The modem unit 23 demodulates the baseband packet signal fed from the RF unit 22, as a receiving processing. The modem unit 23 outputs a MAC frame obtained from the demodulation result, to the MAC processing unit 24. Also, the modem unit 23 modulates the MAC frame fed from the MAC frame processing unit 24, as a transmission processing. The modem unit 23 outputs the modulation result to the RF unit 22 as a baseband packet signal.

The communication system 100 according to the present exemplary embodiment uses an OFDM (Orthogonal Frequency Division Multiplexing) modulation scheme. In this case, the modem unit 23 performs FFT (Fast Fourier Transform) as a receiving processing and performs IFFT (Inverse Fast Fourier Transform) as a transmission processing.

As a receiving processing, the MAC frame processing unit 24 retrieves a security frame from the MAC frame fed from the modem unit 23 and outputs the security frame to the security processing unit 25. As a transmission processing, the MAC frame processing unit 24 adds the MAC header, the LLC header and the information header to the security frame fed from the security processing unit 25, generates a MAC frame, and outputs the MAC frame to the modem unit 23. Also, the timing with which packet signals are transmitted and received is controlled so that the packet signals sent from the other base station apparatus 10 or other terminal apparatuses collide with those sent from its own terminal apparatus 10.

The network communication unit 27 connects to the external network 200. The network communication unit 27 receives road information, regarding the road repairing, congestion situation and the like, from the external network 200. In the present exemplary embodiment, an expired key ID (described later) sent from the system operations management apparatus 300 is received via the road-to-vehicle service company terminal apparatus 400. Also, in the present exemplary embodiment, a table updating key, used to encrypt a common key table for use in update (updating common key table) sent from the system operations management apparatus 300, and an encrypted update common key table, which is encrypted with this table updating key, are received via the road-to-service operations terminal apparatus 400. A list of terminal apparatuses 10, sent from the system operations management apparatus 300, for which the common key table is not to be updated (hereinafter referred to as “device negative list” also) is also received. Those devices registered in the device negative list correspond to a falsified in-vehicle unit and a device where a malfunction has been found and therefore a product recall procedure by a maker is under way, for instance.

Also, the network communication unit 27 outputs the processing result by the security processing unit 25 to the external network 200 and accumulates those processing results and then outputs them to the external network 200 on a regular basis. The data generator 26 generates application data. For example, the road information is set to the application data. Then the protection format is specified according to the content of the application data, and the thus generated application data and its data length are outputted to the security processing unit 25.

The storage 28 stores various items of information. In the present exemplary embodiment, the storage 28 stores the aforementioned common key table, an update master key, which is commonly used within the communication system 500, and the aforementioned device negative list. Note that the common key table and the update master key may be incorporated before the shipment from a factory or they may be obtained thereafter via the network communication unit 27. Also, the storage 28 temporarily stores the device ID and vehicle information acquired from a terminal apparatus 10 and the encrypted update common key table, the table updating key and the road information acquired from the system operations management apparatus 300. The control unit 29 controls the entire processing of the base station apparatus 20.

The security processing unit 25 generates or reads (interprets) a security frame. The security processing unit 25 generates the security frame, which is to be outputted to the MAC frame processing unit 24, based on the data stored in the storage 28. The application data received from the data generator 26 is set to the “application data” of the payload, and the data length is set to the “application data length” of the payload. Alternatively, the expired key ID described later, the encrypted table updating key described later or the encrypted update common key table described later is set to the “management data” as necessary, and then the security header and the security footer are appended so as to generate the security frame. In so doing, the message authentication code is generated and appended, as described above, so that the data can be authenticated. Further, the message can be kept secret by encrypting the payload and the message authentication code.

The security processing unit 25 includes an encryption/decryption unit 251 and an encryption unit 252. The encryption/decryption unit 251 is capable of performing data authentication and encryption on the payload. The security processing unit 25 selects a protection function of the security frame in the light of both a request from the application data instructed by the data generator 26 and a request from the management data set by the security processing unit 25. If the management data is to be sent out, encrypted data with data authentication (=3) will be generally selected. Then the protection function is set to the field of the security frame. Then the security frame to which the protection frame has been set is outputted to the encryption/decryption unit 251. If the protection function is a plain text (=0), the encryption/decryption unit 251 will skip the processing. If it is data with data authentication (=1), a key will be selected from the transmitting table and a message authentication code will be generated using the selected key. Then the key ID of the selected key and the message authentication code are set to the field of the security frame. If it is encrypted data with data authentication (=3), a key will be selected from the transmitting table and a message authentication code will be generated using the selected key and then the key ID of the selected key and the message authentication code will be set to the field of the security frame. Then the payload and the message authentication code are encrypted using the selected key.

To broadcast the identification information on communication keys, which are to be determined unusable, out of a plurality of communication keys included in the common key table (hereinafter referred to as “expired key(s)”), the security processing unit 25 sets the identification information on the expired keys (hereinafter referred to as “expired key ID(s)”) to the management data, as a transmission processing. This expired key ID is data where the message authentication code by which to verify its authenticity is added to the key ID of a communication key to be expired. Also, the security processing unit 25 sets the encrypted table updating key and the encrypted update common key table to the management data. Note that the update common key table is a new common key table to rewrite (update) the common key table stored in the storage 18 of the terminal apparatus 10. The table updating key is a decryption key used to decrypt the encrypted update common key table. Packets in which the expired key ID, the encrypted table updating key and the encrypted update common key table are set may be different or may be identical. If the timings are different, the encrypted table updating key may be broadcast before or after the encrypted update common key table is broadcast. Also, the number of expired key IDs and the number of encrypted table updating keys may each be a single or in plurality.

The encryption unit 252 can generate and encrypt a message authentication code for the management data. In the present exemplary embodiment, the encryption unit 252 runs a predetermined encryption function, which uses the aforementioned update master key and the device ID of a terminal apparatus 10, before the aforementioned table updating key is set to the “management data”. Thereby, an encryption key with which to encrypt the aforementioned table updating key is produced. If the table updating key is sent as the management data, an encrypted table updating key, which has been encrypted with the thus generated encryption key, is set to the “management data”.

Note that the encryption unit 252 does not regard the device IDs of terminal apparatuses 10 included in the aforementioned device negative list, as those for which the encryption key is to be generated. If a table updating key is encrypted using such a device ID, this encrypted table updating key will be removed from those to be broadcast. That is, broadcasting the table updating keys encrypted using such device IDs and the updating master key is stopped. Also, it is obvious that after the data encrypted by the encryption unit 252 has been set to the “management data”, the encryption unit 251 encrypts this data according the protection function of the message type.

As a receiving processing, the security processing unit 25 receives the security frame sent fed from the MAC frame processing unit 24. The security processing unit 25 verifies the content of the security header in the received security frame. If the message type is data with data authentication, the message will be verified at the encryption/decryption unit 251. If the message type is encrypted data with data authentication, the message will be verified at the encryption/decryption unit 251 and then decrypted. If the message is a plain text, these processes will be skipped.

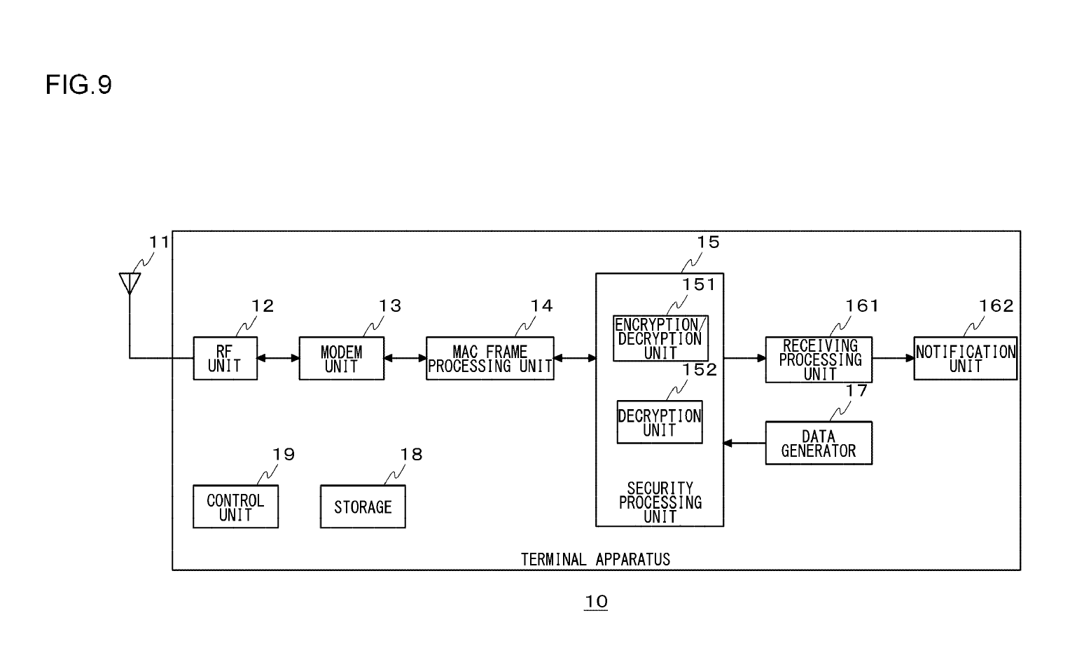

FIG. 9 shows a structure of a terminal apparatus 10 installed in a vehicle 100. The terminal apparatus 10 includes an antenna 11, an RF unit 12, a modem unit 13, a MAC frame processing unit 14, a security processing unit 15, a receiving processing unit 161, a notification unit 162, a data generator 17, a storage 18, and a control unit 19. The security processing unit 15 includes an encryption/decryption unit 151 and a decryption unit 152.

The MAC frame processing unit 14, the security processing unit 15, the receiving processing unit 161, the notification unit 162, the data generator 17, the storage 18 and the control unit 19 may be configured hardwarewise by elements such as any given processor, memory and other LSIs and/or may be configured softwarewise by memory-loaded programs or the like. Depicted herein are functional blocks implemented by cooperation of hardware and software. Therefore, it will be obvious to those skilled in the art that theses functional blocks may be implemented by a variety of manners including hardware only, software only or a combination of both.

The structures and operations of the antenna 11, the RF unit 12, the modem unit 13 and the MAC frame processing unit 14 are basically similar to those of the antenna 21, the RF unit 22, the modem unit 23 and the MAC frame processing unit 24 of FIG. 2, respectively. A description is given hereunder of the components of the terminal apparatus 10 centering around differences from those of FIG. 2.

The receiving processing unit 161 estimates a crash risk, an approach of an emergency vehicle, such as an ambulance vehicle and a fire-extinguishing vehicle, a congestion situation in a road ahead and intersections, and the like, based on the information on his/her own vehicle received from the data generator 17. If the data is image information, the data will be processed so that it can be displayed by the notification unit 162.

The notification unit 162 includes a means for notifying the user such as a monitor, a lamp, and a speaker, all of which are not shown. The approach of other vehicles (not shown) and the like are conveyed to a driver, via the notifying means, according to instructions given from the receiving processing unit 161. Also, the congestion information, the image information on the intersections and other information are displayed on the monitor.

The data generator 17 identifies the present position, traveling direction, traveling speed and so forth of the vehicles 100 that are carrying the terminal apparatuses 10, based on the information supplied from a GPS receiver, a gyroscope, a vehicle speed sensor, and so forth all of which are not shown in FIG. 9. The present position thereof is indicated by the latitude and longitude. Known art may be employed to identify those items of information and therefore the description thereof is omitted here. The data generator 17 generates data, which is to be broadcast to the other terminal apparatuses 10 and the base station apparatus 20, based on the identified information and then outputs the generated data (hereinafter referred to as “application data” also) to the security processing unit 15. Also, the generated information is outputted to the receiving processing unit 161 as the information on his/her own vehicle.

The storage 18 stores various items of information. In the present exemplary embodiment, the storage 28 stores the aforementioned common key table, the update master key, which is commonly used within the communication system 500, and its own device ID. Note that the common key table and the update master key may be incorporated before the shipment from a factory or they may be obtained thereafter via the RF unit 12. Also, the storage 18 temporarily stores the vehicle information on its own vehicle, the vehicle information, acquired from other terminal apparatuses 10, regarding vehicles other than its own vehicle, the expired key IDs acquired from the base station apparatus 20, the encrypted update common key table, the encrypted table updating key and the road information. The control unit 19 controls the entire processing of the terminal apparatus 10.

The security processing unit 15 generates or reads (interprets) a security frame. The security processing unit 15 generates the security frame, which is to be outputted to the MAC frame processing unit 14, based on the data stored in the storage 18. For example, the security frame is generated such that the vehicle information on its own vehicle is set to the “application data” of the payload or its own device ID is set to the “device ID” and then the security header and the security footer are appended. In so doing, the message authentication code is generated, as described above, so that the data can be authenticated. Further, the payload and the message authentication code can be encrypted.

The security processing unit 15 includes an encryption/decryption unit 151 and a decryption unit 152. The encryption/decryption unit 151 is capable of performing data authentication and encryption on the payload. In other words, the security processing unit 15 performs a processing according the protection function of the message type and includes the function equivalent to that of the encryption/decryption unit 251 of the base station apparatus 20. Thus the transmission processing and the receiving processing of the security processing unit 15 are basically the same as those of the encryption/decryption unit 251 of the base station apparatus 20 and therefore the repeated description thereof is omitted here.

In the present exemplary embodiment, the security processing unit 15 generates the security frame in which its own device ID has been set to the “device ID” and then outputs the thus generated frame to the MAC frame processing unit 14. The MAC frame processing unit 14, the modem unit 13 and the RF unit 12 broadcast, from the antenna 11, a packet signal in which a MAC frame including this security frame is stored. As a result, its own device ID can be broadcast.

The RF unit 12 receives a packet signal from the base station apparatus 20. The RF unit 12 outputs the received packet signal to the modem unit 13. More specifically, the RF unit 12 receives, from the base station apparatus 20 that has acquired the device ID, a packet signal in which an encrypted table updating key encrypted using the device ID and the master key possessed by the base station apparatus 20 is stored. Also, the RF unit 12 receives, from the base station apparatus 20, a packet signal in which an encrypted update common key table encrypted with the table updating key is stored. The encrypted table updating key and the encrypted common key table are set to the “management data” of the payload. The encrypted table updating key and the encrypted common key table may be stored in the same packet signal.

The RF unit 12 outputs these packet signals to the modem unit 13, and the modem unit 13 demodulates the packet signals and outputs the demodulated signals to the MAC processing unit 14. The MAC processing unit 14 retries the security frame from the MAC frame and outputs it to the security processing unit 15.

The security processing unit 15 outputs the security frame, received from the MAC frame processing unit 14, to the encryption/decryption unit 151. Upon receiving the security frame, the encryption/decryption unit 151 performs a processing according the protection function of the message type and returns the security frame to the security processing unit 15. At this time, the result of the data verification is also conveyed. Upon receiving an output from the encryption/decryption unit 151, the security processing unit 15 outputs the processing result, the application data length and the application data to the receiving processing unit 161. If the data is authenticated, the management data length and device management data will be outputted to the decryption unit 152. If an encrypted table updating key is included in the management data, the decryption unit 152 will use its own device ID and the update master key so as to decrypt the encrypted table updating key. Then the thus decrypted table updating key is held inside. If an encrypted update common key table is included in the management data inputted from the encryption/decryption unit 151, the encrypted update common key table will be decrypted using the table updating key kept therein and the result of the decryption will be verified. Then if the verification is successful, it will be determined to be an updating common key table. A detail description of this verification processing will be discussed later. If an expired key ID is included in the management data, the expired key ID will be verified using the message authentication code appended to the expired key ID. A detailed description of this verification processing will be discussed later.

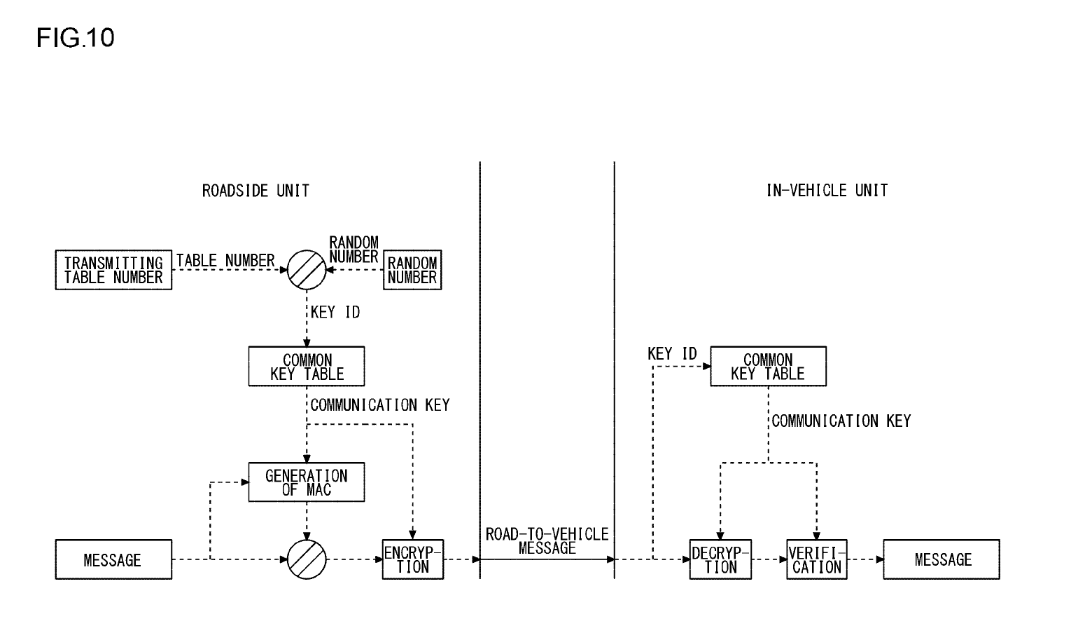

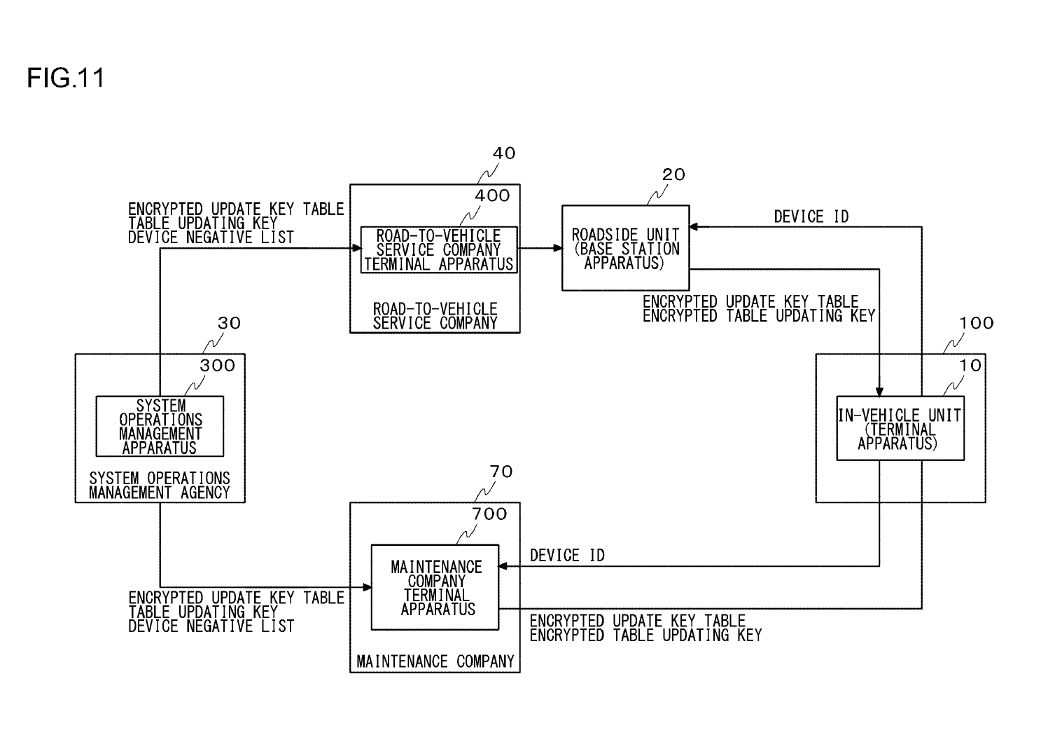

FIG. 10 is a diagram to explain the transmission of messages from a roadside unit (base station apparatus 20) to an in-vehicle unit (terminal apparatus 10) in the road-to-vehicle communication. The processing carried out by the roadside unit (base station apparatus 20) corresponds to the processing carried out by the encryption/decryption unit 251, whereas the processing by the in-vehicle unit (terminal apparatus 10) corresponds to the processing by the encryption/decryption unit 151. It is assumed, in FIG. 11, that the encrypted data with data authentication is selected as the message type (protection function). As for the others, unnecessary processes are skipped and what to be done is obvious accordingly. The encryption/decryption unit 251 combines the table number of a transmitting table with a random number so as to generate a key ID. At this time, the random numbers for the transmitting table are generated randomly within a range of the number of keys included in the transmitting table. In the present exemplary embodiment, they are generated randomly in a rage of 0 to 15. At this time, “nega-flag(s)” (negative flag(s)) of a transmitting table is/are verified; if the communication key specified by the generated key ID is unusable, a key ID will be generated again. This process is repeated until the communication key specified by the generated key ID is usable.

The encryption/decryption unit 251 reads out a communication key of a common key table based on the generated key ID, as the communication key to be used this time. The encryption/decryption unit 251 generates a message authentication code (MAC) based on data, available in a data authentication range of a message to be broadcast to the in-vehicle unit, and the communication key. Then the thus generated MAC is set to the “message authentication code” of the message and is encrypted together with the “payload” using the communication key. Note that data included in the payload of this message may be application data or management data or may be the both. The message generated in this manner is broadcast as a road-to-vehicle message.

The encryption/decryption unit 151 reads out a communication key (i.e., communication key) of a common key table set in the transmitting table, based on the key ID contained in the received message. The encryption/decryption unit 151 decrypts an encrypted part of the message using the communication key. As a result, the message authentication code is also decrypted. The encryption/decryption unit 151 verifies the received message using the decrypted MAC and the communication key. If the verification is successful, the received message will be reported as an authentic message. For the sake of simplicity in explanation, a description regarding the generation of the MAC frame and the modulation process is omitted here. The procedure shown in FIG. 10 is similar to that in transmitting the message in the inter-vehicular communication.

Next a description is given of a process for rewriting a common key table. What is to be rewritten is a common key table that is not set in the transmitting table. Though a certain security level can be ensured by switching a plurality of common key tables to be used, the security level will naturally deteriorate as a whole if used for a long period of time. Thus the following is conceivable to enhance the security level. That is, the common key table, which is not set in the transmitting table and which is ready and waiting, is rewritten or renewed in units of table.

FIG. 11 is a diagram to explain how a common key table is rewritten or renewed. In the present exemplary embodiment, a new common key table to be updated is generated by the system operations management agency 30. A system operations management apparatus 300 of the system operations management agency 30 transmits the above-described encrypted update common key table, the above-described table updating key and the above-described device negative list to each of a road-to-vehicle service company terminal apparatus 400 of a road-to-vehicle service company 40 and a maintenance company terminal apparatus 700 of a maintenance company 70. The maintenance company terminal apparatus 700 may be a roadside unit installed at a maintenance factory. The road-to-vehicle service company terminal apparatus 400 transmits the encrypted update common key table, the table updating key and the device negative list, all of which have been received from the system operations management apparatus 300, to the roadside unit (base station apparatus 20).

The roadside unit acquires a device ID from the in-vehicle unit (terminal apparatus 10) of an existing vehicle 100, encrypts the table updating key using its device ID, and supplies the encrypted table updating key and the encrypted update common key table to the in-vehicle unit. Similarly, the maintenance company terminal apparatus 700 acquires the device ID from the in-vehicle unit (terminal apparatus 10) of the existing vehicle 100, encrypts the table updating key using its device ID, and supplies the encrypted table updating key and the encrypted update common key table to the in-vehicle unit.

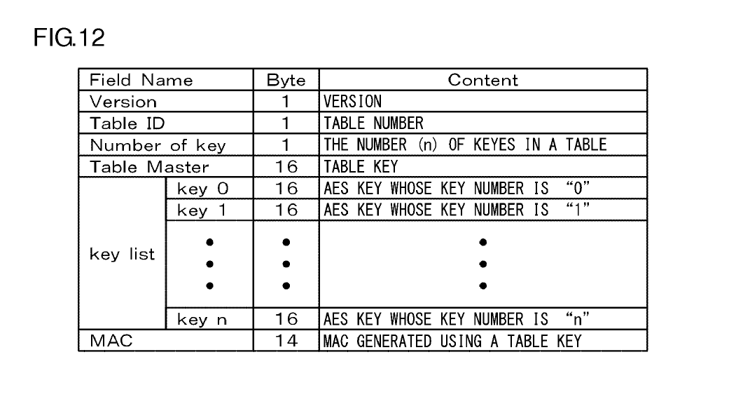

FIG. 12 shows a format of a common key table. “Version”, “table ID”, “the number of keys”, “table master”, “key list” and “MAC” are provided in a “field” of the common key table. The “key list” includes “key 0” to “key n (n being a natural number)”.

An area of 1 byte is assigned to each of “version”, “table ID” and “the number of keys”. An area of 16 bytes are assigned to each of “table master”, “key 0”, . . . , and “key n”. An area of 14 bytes is assigned to “MAC”.

A table number is set to the “table ID”. A number n, which indicates the number of keys in a table, is set to “the number of keys”. In the example of FIG. 7, 15 is set. Note that “0” is also included and therefore 16 kinds of keys are available altogether. A table key (table master key) is set to the “table master”. An AES key whose key number is “0” is set to the “key 0”. An AES key whose key number is “1” is set to the “key 1”. The setting will be similarly done up to the “key n”. A MAC (Maintenance Authentication Code) generated using a table key of the previous common key table is set to “MAC”. That is, a MAC, which is generated by use of a table key included in a common key table whose table number is (m−1), is set to “MAC” of a common key table whose table number is m (m being a natural number).

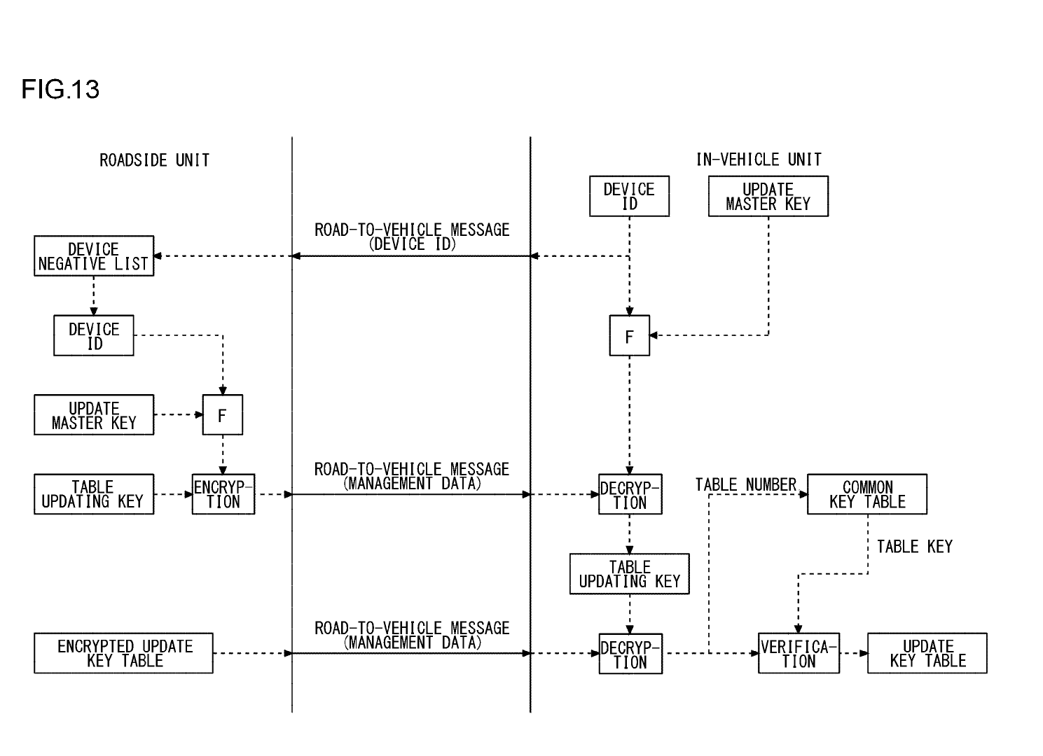

FIG. 13 is a diagram to explain the updating of a common key table from a roadside unit (base station apparatus 20) to an in-vehicle unit (terminal apparatus 10) in the road-to-vehicle communication. It is assumed, in FIG. 13, that the data with data authentication or the encrypted data with data authentication is selected as the message type. The security processing unit 15 of the in-vehicle unit generates a message containing its own device ID stored in the storage 18, and the thus generated message is transmitted by broadcast. The security processing unit 25 of the roadside unit, which has received the message containing the device ID, retrieves the device ID from the message and determines if the retrieved device ID is registered in the device negative list. If the retrieved device ID is registered in the device negative list, the subsequent processings will not be carried out.

If the retrieved device ID is not registered in the device negative list, the encryption unit 252 will run a predetermined encryption function that uses the update master key stored in the storage 28 and the device ID so as to generate another encryption key. The encryption unit 252 encrypts the table updating key using the other encryption key. The security processing unit 25 sets this encrypted table updating key in the “management data” of the payload in the message. Then the message is processed at the encryption/decryption unit 251 and then the thus processed message is broadcast in the road-to-vehicle communication. Also, in another communication packet, the security processing unit 25 sets the encrypted update common key table to the “management data” of the payload in the message. Then the message is processed at the encryption/decryption unit 251 and then the thus processed message is broadcast in the road-to-vehicle communication. Though, in the example of FIG. 13, the encrypted update common key table is broadcast after the encrypted table updating key is broadcast, the encrypted update common key table may be broadcast before the encrypted table updating key. Although the encrypted table updating keys are transmitted individually in the above description, a plurality of encrypted table updating keys each for a different in-vehicle unit may all be assigned to the management data of the same packet and then transmitted as a single packet.

When the common key table is updated, the in-vehicle unit receives a message containing the management data, namely the encrypted table updating key, or a message containing the encrypted update common key table. The decryption unit 152 of the in-vehicle unit runs a predetermined encryption function that uses its own device ID and the update master key stored in the storage 18 so as to generate an encryption key. The encryption function used here is the same encryption function run at the roadside unit.

The decryption unit 152 further decrypts the encrypted table updating key contained in the message received from the roadside unit by use of the generated encryption key. Thereby, the encrypted update common key table contained in the message received from the roadside unit is decrypted.

The decryption unit 152 references the table number m included in the updating common key table obtained by further decrypting the encrypted update common key table and then reads out a table key included in a common key table of the same table number m stored in the storage 18. The generation management of tables denoted by an identical table number is done by identifying its version. If the version differs, this means that a different table key is set. Then the message authentication code included in the updating common key table is verified using the table key. If the verification is successful, it will be determined that the received common key table is authentic and is a common key table that is stored in the storage 18, and then the common key table, whose table number is m, which is stored in the storage 18 will be rewritten with the updating common key table. If encrypted data with data authentication is selected as the message type, the encrypted data with data authentication must be verified authentic; that is, the encrypted data with data authentication needs to be decrypted and the message authentication code needs to be verified by the encryption/decryption unit 151 before it is decrypted by the decryption unit 152 so as to be verified authentic. For the sake of simplicity in explanation, a description regarding the generation of the MAC frame and the modulation process is omitted in FIG. 13.

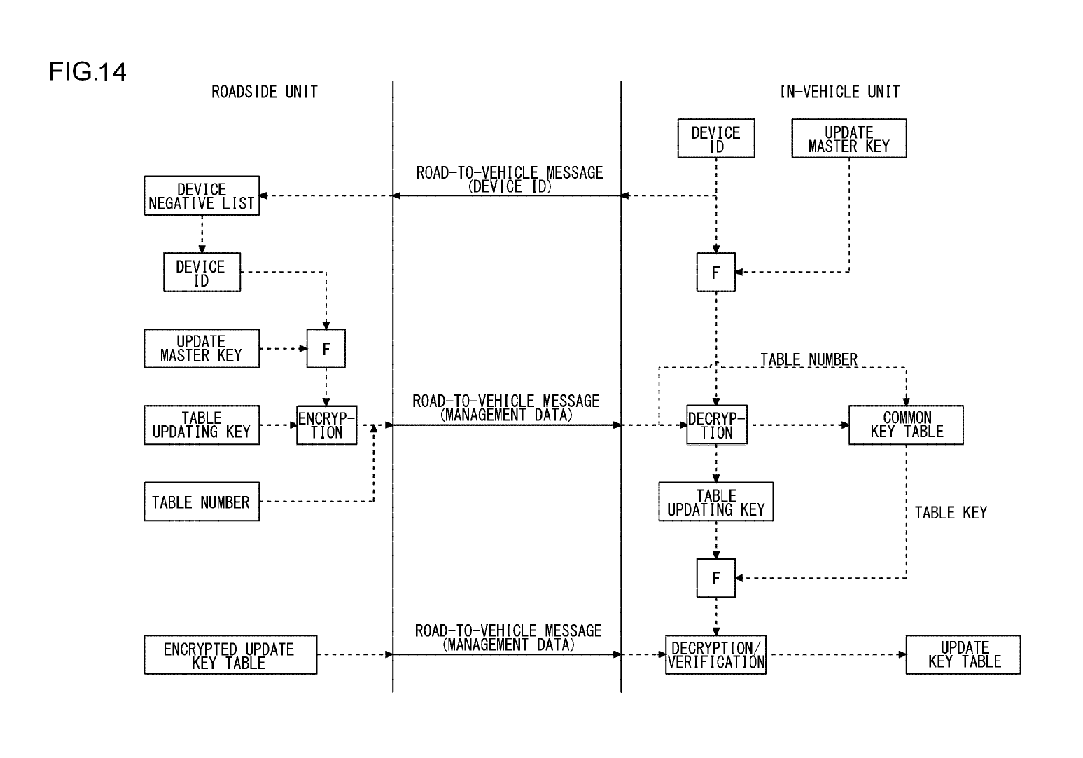

FIG. 14 is a diagram to explain a modification to the updating of a common key table from a roadside unit (base station apparatus 20) to an in-vehicle unit (terminal apparatus 10) in the road-to-vehicle communication. The security processing unit 15 of the in-vehicle unit generates a message containing its own device ID stored in the storage 18. The thus generated message is transmitted by broadcast. The security processing unit 25 of the roadside unit, which has received the message containing the device ID, retrieves the device ID from the message and determines if the retrieved device ID is registered in the device negative list. If the retrieved device ID is registered in the device negative list, the subsequent processings will not be carried out.

If the retrieved device ID is not registered in the device negative list, the encryption/decryption unit 251 will run a predetermined encryption function that uses the update master key and the device ID stored in the storage 28 so as to generate another encryption key. The encryption/decryption unit 251 encrypts the table updating key using the other encryption key and combines it with the table number m of the updating common key table. This concatenated data where the encrypted table updating key and the table number are combined together is set to the “management data” of the payload in the message and then this message is broadcast via the road-to-vehicle communication. The encrypted update common key table is also set to the “management data” of the payload in the message and this message is broadcast via the road-to-vehicle communication.

The in-vehicle unit receives a message containing the concatenated data, where the encrypted table updating key and the table number are combined together, and a message containing the encrypted update common key table. The encryption/decryption unit 151 of the in-vehicle unit runs a predetermined encryption function that uses its own device ID and the update master key stored in the storage 18 so as to generate an encryption key. The encryption function used here is the same encryption function run at the roadside unit.

The decryption unit 152 separates the encrypted table updating key and the table number contained in the message received from the roadside unit by use of the generated encryption key so as to decrypt the encrypted table updating key. Then the decryption unit 152 references the table number m of the common key table and reads out a table key included in the common key table, whose table number is m of one generation earlier, stored in the storage 18. The generation management of tables denoted by an identical table number is done by identifying its version.

The decryption unit 152 runs a predetermined encryption function, which uses the further decrypted table updating key and the read-out table key, so as to generate another decryption key. The encryption function used here is different from the encryption function that uses the device ID and the update master key.

The decryption unit 152 decrypts the encrypted update common key table using this encryption key and, at the same time, verifies a message authentication code included in the decrypted common key table.

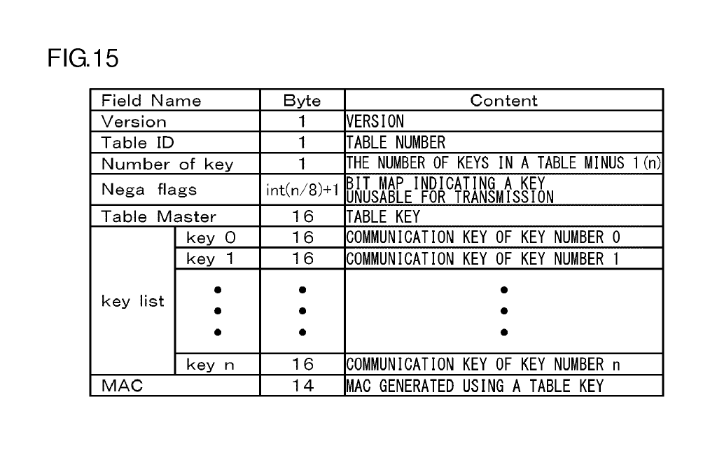

FIG. 15 shows a format of a common key table with a negative flag. “Version”, “table ID”, “nega flags”, “the number of keys”, “table master”, “key list” and “MAC” are provided in a “field” of the common key table. The “key list” includes “key 0” to “key n (n being a natural number)”.

An area of 1 byte is assigned to each of “version”, “table ID” and “the number of keys”. An area of (int(n/8)+1) bytes (i.e., the minimum number of bytes for which the area of (n+1) bits can be ensured) is assigned to “nega-flags” (negative flags). Here, int( ) is a function by which an integral part is retrieved. An area of 16 bytes is assigned to each of “table master”, “key 0”, . . . , and “key n”. The area of 14 bytes is assigned to “MAC”.

A table number is set to the “table ID”. A number n, which indicates the number of keys in a table minus 1, is set to “the number of keys”. In the example of FIG. 7, 15 (n=15) is set. Note that “0” is also included and therefore the number of communication keys is 16. A bit map indicating whether or not a key in a table is usable is set to the “nega-flags”. In the example of FIG. 7, 16 bit data is required for 16 keys and therefore an area of 2 bytes is prepared and each bit corresponds to each key number. The bit value “0” indicates that the key is usable and the bit value “1” indicates that it is not usable. A table key (table master key) is set to the “table master”. A communication key whose key number is “0” is set to the “key 0”. A communication key whose key number is “1” is set to the “key 1”. The setting will be similarly done up to the “key n”. A MAC (Message Authentication Code) generated using a table key of the common key table is set in the encryption/decryption unit 251 and the encryption/decryption unit 151. In the present exemplary embodiment, n is 15. All roadside units and all in-vehicle units store this common key table therein.

When a common key table with a negative flag is to be used, the procedure performed at a receiving side is changed, as follows, in the procedure for transmitting messages in both the road-to-vehicle communication and the inter-vehicular communication described with reference to FIG. 10. That is, the encryption/decryption unit 151 reads out a common key (i.e., communication key) of a common key table set to the transmitting table, based on a key ID contained in the received message. At this time, “nega-flags” are verified as well. If the communication key for the key ID is unusable, the verification will fail. If the communication key for the key ID is usable, the encryption/decryption unit 151 will decrypt an encrypted part of the message using the communication key. This also decrypts the message authentication code (MAC). The encryption/decryption unit 151 verifies the received message using the decrypted MAC and the communication key. If the verification is successful, the received message will be reported as an authentic message.

A description is now given of a process for rewriting the “nega-flags” of a common key table due to the expired key IDs. An expired key is a communication key that has been leaked or might have possibly been leaked. If, for example, it is verified that the communication key has been leaked through an unauthorized communication interception, the expired key will correspond to the communication key used in the communication message. Besides theses, a communication key, which is determined to be invalid by the system operations management agency 30, is regarded as an expired key. For example, a communication key in which error occurs in encryption/decryption computation is regarded as an expired key.

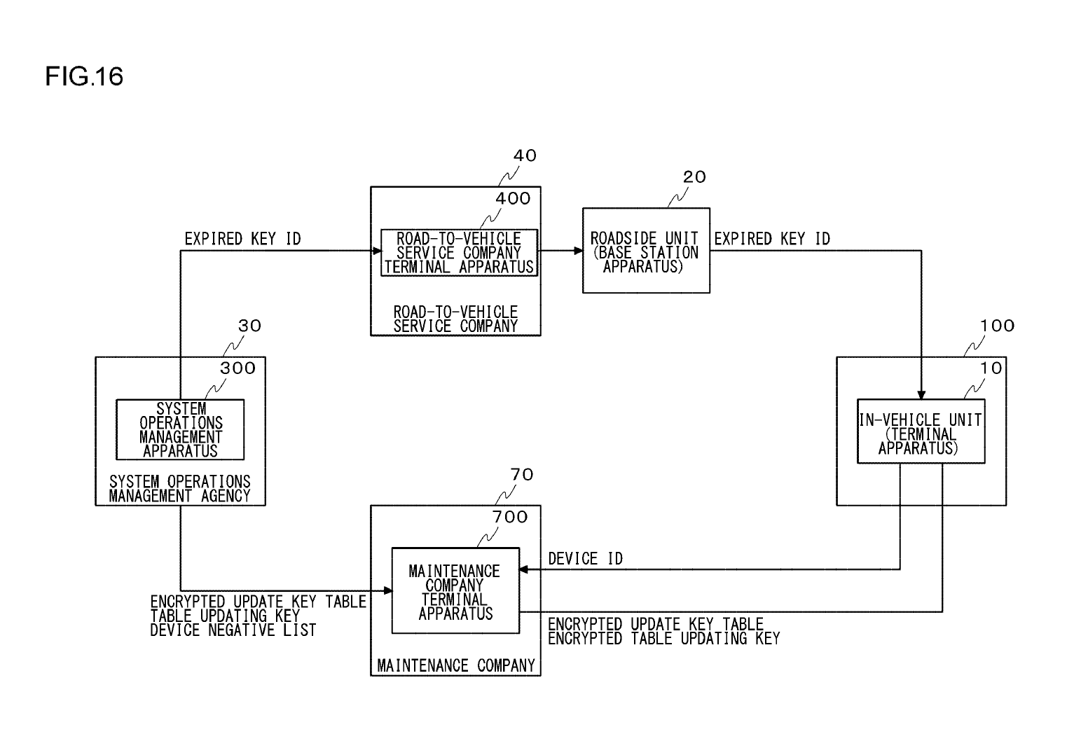

FIG. 16 is a diagram to explain how the “nega-flags” of a common key table is rewritten or renewed due to the expired key IDs. In the present exemplary embodiment, an expired key ID is generated by the system operations management agency 30. Included in this expired key ID is a message authentication code (MAC) that can be verified by use of a table key of a common key table including a communication key specified by the key ID, in addition to the key ID of an expiring communication key. The system operations management apparatus 300 of the system operations management agency 30 transmits the expired key ID to the road-to-vehicle service company terminal apparatus 400 of the road-to-vehicle service company 40. The road-to-vehicle service company terminal apparatus 400 transmits the expired key ID to the roadside unit (base station apparatus 20). This roadside unit supplies the received expired key ID to the in-vehicle unit of an existing vehicle 100. Upon receiving the expired key ID, the in-vehicle unit of the existing vehicle 100 verifies the expired key ID. If its authenticity is verified, “1” indicating that the key is not usable is set to the “nega-flags” of the common key table identified by the key ID specified by the expired key ID.

The common key table including the expired key (i.e., common key table with a negative flag) can also be rewritten in its entirety. The system operations management apparatus 300 transmits the encrypted update common key table, in which the common key table with the negative flag has been encrypted, the table updating key with which to decrypt the encrypted update common key table, and the device negative list to the maintenance company terminal apparatus 700 of a maintenance company 70. In the present exemplary embodiment, a roadside unit (base station apparatus 20) installed at a maintenance facility is assumed as the maintenance company terminal apparatus 700

This roadside unit acquires the device ID from the in-vehicle unit of the existing vehicle 100 (terminal apparatus 10), encrypts the table updating key by use of the device ID, and supplied this encrypted table updating key and the aforementioned encrypted update common key table to the in-vehicle unit. It goes without saying that the encrypted table updating key and the encrypted update common key table may be supplied from a general roadside unit installed at a site excluding the maintenance facility.

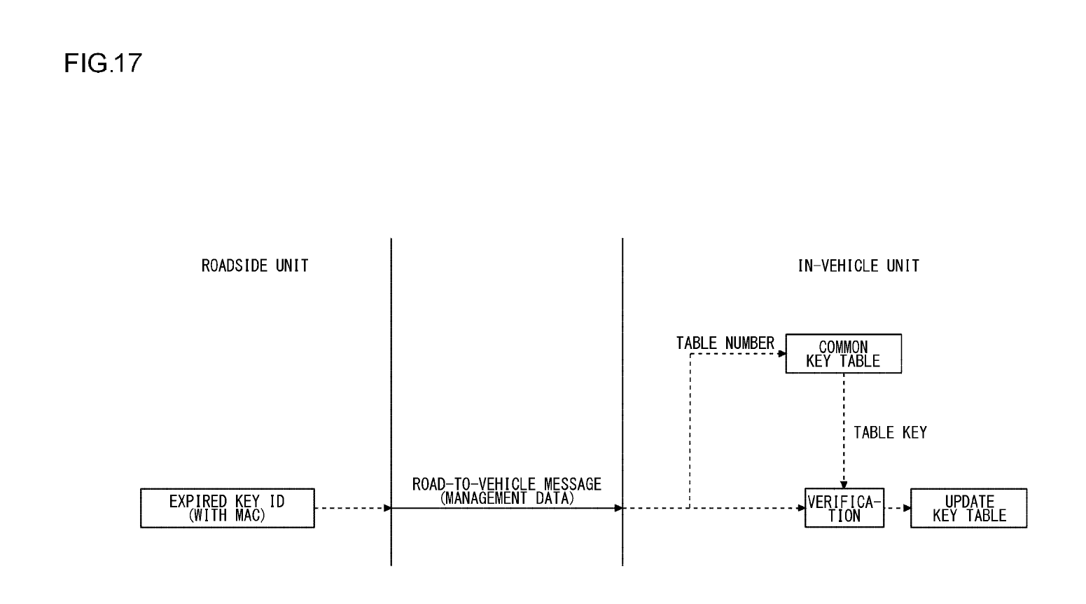

FIG. 17 is a diagram to explain the expiration of a common key from a roadside unit (base station apparatus 20) to an in-vehicle unit (terminal apparatus 10) in the road-to-vehicle communication. FIG. 17 depicts a processing concerning “management data”, namely only a processing for an expired key ID. The processing in the in-vehicle unit is done by the decryption unit 152. As described earlier, the processing by use of a message type is done in the road-to-vehicle message, besides the processing by the decryption unit 152. If the expired key ID is included in the management data, the message type, which is either data with data authentication or encrypted data with data authentication, will be selected so that the source of the management data can be identified. It is assumed herein that encrypted data with data authentication is selected. The processing concerning the message type is carried out immediately before the transmission of the road-to-vehicle message at a transmitting side (roadside unit), whereas it is carried out immediately after the receiving of the road-to-vehicle message at a receiving side (in-vehicle unit). For the sake of simplicity in explanation, a description regarding the MAC frame process, the modulation process and the process by use of a message type is omitted in FIG. 17. The security processing unit 25 of the roadside unit sets the expired key ID, which is received from the road-to-vehicle service company terminal apparatus 400, or the expired key ID, which is received from the road-to-vehicle service company terminal apparatus 400 and then stored in the storage 28, to the “management data” of the payload in the message, and outputs it to the encryption/decryption unit 251. Then the encryption/decryption unit 251 broadcasts the message, which has undergone the process by use of the message type, in the road-to-vehicle communication.

Upon receiving the road-to-vehicle message, the security processing unit 15 of the in-vehicle unit outputs the received road-to-vehicle message to the encryption/decryption unit 151. The encryption/decryption unit 151 performs a receiving processing concerning the message type and returns its result to the security processing unit 15. If the received message is determined to be authentic by the verification and if the expired key ID is included in the management data, the expired key ID will be outputted to the decryption unit 152. The decryption unit 152 references the table number included in this expired key ID and reads out a table key included the common key table of this table number. Then the message authentication code included in the expired key ID is verified using this read-out table key. If the verification is successful, the encryption/decryption key 151 will reference the table number and the key number included in this expired key ID and invalidate the communication key included in the corresponding common key table. That is, “1” indicating that the key is not usable is set to a bit corresponding to the key number included in the expired key ID in the “nega-flags” of the common key table specified by the table number included in the expired key ID. Though a description has been given of the transmission processing and the receiving processing of the road-to-vehicle message including the expired ID, there is no need to have the expired key ID included in the road-to-vehicle communication message if there is no need to distribute the expired key ID. Even though the expired key ID needs to be distributed, it is not necessary to have the expired key ID included in all road-to-vehicle communication messages. It is only necessary to transmit road-to-vehicle messages including the expired key ID so long as there is no hindrance of normal servicing by the road-to-vehicle messages.

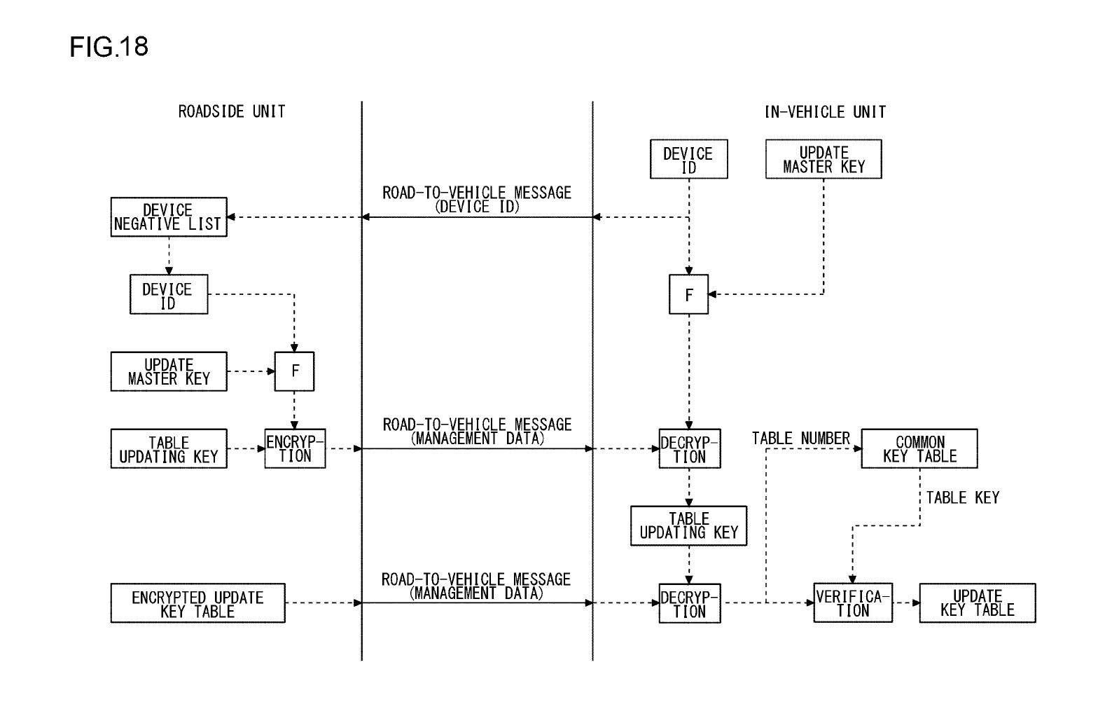

FIG. 18 is a diagram to explain the updating of a common key table with a negative flag from a roadside unit (base station apparatus 20) to an in-vehicle unit (terminal apparatus 10) in the road-to-vehicle communication. Similar to FIG. 17, a description regarding the MAC frame process, the modulation process and the process by use of a message type is omitted in FIG. 18 for the sake of simplicity in explanation. The processing done in the roadside unit corresponds to the processing done by the decryption unit 252, and the processing done in the in-vehicle unit corresponds to the processing done by the decryption unit 152. While referencing a received inter-vehicular communication message, the in-vehicle security processing unit 15 gathers the device IDs of in-vehicle units installed in vehicles 100 running around its own vehicle. Then the security processing unit 15 selects a device ID from the thus gathered device IDs. Then the selected device ID is inputted to the encryption unit 252. Upon receiving the device ID, the encryption unit 252 determines if the received device ID is registered in the device negative list stored in the storage 28. If the received device ID is registered, the subsequent processings will not be carried out.

If the received device ID is not registered in the device negative list, the encryption unit 252 will run a predetermined encryption function that uses the update master key stored in the storage 28 and the device ID so as to generate another encryption key. The encryption unit 252 encrypts the table updating key using the other encryption key. The security processing unit 25 sets this encrypted table updating key to the “management data” of the payload in the message. Then the message is processed at the encryption/decryption unit 251 and then the thus processed message is broadcast in the road-to-vehicle communication. Also, in another road-to-vehicle message, the security processing unit 25 sets the encrypted update common key table to the “management data” of the payload in the message. Then the message is processed at the encryption/decryption unit 251 and then the thus processed message is broadcast in the road-to-vehicle communication. Though, in the example of FIG. 18, the encrypted update common key table is broadcast after the encrypted table updating key is broadcast, the encrypted update common key table may be broadcast before the encrypted table updating key. Although the encrypted table updating keys are transmitted individually in the above description, a plurality of encrypted table updating keys each for a different in-vehicle unit may all be assigned to the management data of the same road-to-vehicle message and then transmitted. It is not necessary that the number of broadcasting the road-to-vehicle message containing the encrypted table updating key and the number of broadcasting the road-to-vehicle message containing the encrypted update common key table be agreed with each other. If the number of broadcasting the road-to-vehicle message containing the encrypted table updating key is made larger than the number of broadcasting the road-to-vehicle message containing the encrypted update common key table, one-time broadcasting of the road-to-vehicle message containing the encrypted update common key table will enable a plurality of in-vehicle units to rewrite their common key tables. Thus the traffic used in the rewiring of the common key tables can be reduced.

Upon receiving the road-to-vehicle message, the security processing unit 15 of the in-vehicle unit outputs the received road-to-vehicle message to the encryption/decryption unit 151. The encryption/decryption unit 151 performs a receiving processing concerning the message type and returns its result to the security processing unit 15. If the received message is determined to be authentic by the verification and if an encrypted table updating key addressed to its own message is included, the security processing unit 15 will output the encrypted table updating key to the decryption unit 152. The decryption unit 152 of the in-vehicle unit runs a predetermined encryption function that uses its own device ID and the update master key stored in the storage 18 so as to generate an encryption key, and the thus generated encryption key is held inside. The encryption function used here is the same encryption function run at the roadside unit.

If the received message is determined to be authentic by the verification and if the encrypted update common key table is included, the security processing unit 15 will output the encrypted update common key table to the decryption unit 152. If the encrypted update key table is received while the generated encryption key is being held inside, the decryption unit 152 will further decrypt the encrypted table updating key contained in the message received from the roadside unit by use of the generated encryption key. Thereby, the encrypted update common key table contained in the message received from the roadside unit is decrypted.

The decryption unit 152 references the table number m included in the common key table with a negative flag obtained by further decrypting the encrypted table updating key and the encrypted update common key table and then reads out a table key included in a common key table of the same table number m stored in the storage 18. The generation management of tables denoted by an identical number m is done by identifying its version. If the version differs, this means that a different table key m is set. Then the message authentication code included in the common key table with the negative flag is verified using the table key. If the verification is successful, it will be determined that the received common key table with the negative flag is authentic and is a common key table that is stored in the storage 18, and then the common key table, whose table number is m, which is stored in the storage 18 will be rewritten with the common key table with the negative flag. Though a description has been given of the transmission processing and the receiving processing of the road-to-vehicle message including the encrypted table updating key or the encrypted update common key table, there is no need to have the encrypted table updating key or the encrypted update common key table included in the road-to-vehicle communication message if there is no need to update the common key table. Even though the common key table needs to be updated, it is not necessary to have the encrypted table updating key or the encrypted update common key table included in all road-to-vehicle communication messages. It is only necessary to transmit road-to-vehicle messages including the encrypted table updating key or the encrypted update common key table so long as there is no hindrance of normal servicing by the road-to-vehicle messages. The road-to-vehicle messages are distributed, as appropriate, to the extent that the normal servicing is not obstructed.

By employing the present exemplary embodiment as described above, a table updating key, which is used to decrypt an encrypted update common key table, is encrypted and then this encrypted table updating key and the encrypted update common key table are broadcast from a base station apparatus to terminal apparatuses. Thus the safety in updating a common key table can be enhanced. Also, a message authentication code is given in the common key table, so that the authenticity of a common key table for use in update can be verified. Also, the message authentication code is generated using a table key of a common key table which is one generation earlier than the updating common key table. This can prevent the updating common key table from being repeatedly updated at a terminal apparatus.

The expired key IDs are broadcast from the base station apparatus to the terminal apparatuses. This can recover the reduced security resulting from the leakage of a common key in the road-to-vehicle communication or the inter-vehicular communication. Provision of a message authentication code in an expired key ID can verify the authenticity of the expired key ID. Also, use of a common key table with a negative flag can broadcast an unusable common key in units of common key table.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

As for a message containing an encrypted table updating key, this message may be transmitted by unicast, for example, where its destination is specified, instead of being transmitted by broadcast.

Though in the above-description exemplary embodiments a description has been given of an example where a message authentication code is appended to a security footer, an electronic signature may be appended thereto instead. Since an electronic signature is encrypted using a public key encryption scheme, a secret key and a public key are used in addition to a common key.

In the above-described exemplary embodiments, a description has been given of a method where the negative flag of the common key table with the negative flag stored in an in-vehicle unit is updated using the management data of the road-to-vehicle message. This should not be considered as limiting and, for example, the common key table with the negative flag at the roadside unit may be updated using a similar encryption process. Also, an inter-vehicular message may be distributed by changing the negative flag such that the management data is included in the inter-vehicular message. This can smoothly transmit the expired key IDs in an area where not many roadside units are available. Also, in the above-described embodiments, a description has been given of an example where the system operations management apparatus 300 of the system operations management agency 30 sets a message authentication code (MAC) included in an expired key ID, encrypts the common key table with the negative flag and so forth. This should not be considered as limiting and, for example, these can be done by the roadside unit. In such a case, these are carried out by the encryption unit 252.

In the above-described exemplary embodiments, a description has been given of cases where a message authentication code (MAC) using a common key encryption method is used to verify the authenticity of messages or data. Instead, an electronic signature using a public key method may be used. In this case, the common key table is used to encrypt the payload and the electronic signature. Also, in this case, it is preferable that a public key certificate with the device ID included therein be set to the “device ID” of a security frame and that the electronic signature be set to the “message authentication code”. Similarly, it is preferable that a public key for use in verification is set to the “table master” and the electronic signature be set to the “MAC” in verifying the authenticity of the common key table with the negative flag.

In the above-described embodiments, a description has been given of a case where the expired key ID is distributed from a roadside unit that provides a normal service or the encrypted table updating key and the encrypted update common key table are distributed therefrom. Instead, a roadside unit that does not provide the normal service may be used. A vehicle moves to a communication spot where there is a roadside unit used exclusively for the distribution and then receives the distribution of the expired key ID, the encrypted table updating key and the encrypted update common key table.

In the above-described embodiments, a description has been given of a case where a common key table is updated with reference to FIG. 11 to FIG. 13. In this procedure for updating the common key table, a roadside unit (base station apparatus 20) acquires a device ID of the in-vehicle unit (terminal apparatus 10) and encrypts the table updating key by use of an update master key that is commonly used in the communication system 500. Then the common key table is encrypted with its table updating key. In the following modification, a description is given of an example where, instead of the update master key, a key bound to or associated with an in-vehicle unit is used. It is assumed, in the following modification, that a security application module (SAM) (hereinafter referred to as “security module” also) is used for the security processing unit 15 of the terminal apparatus 10 shown in FIG. 9. The SAM is a device where a security function having a tamper resistance is incorporated into a single chip.

A registration key embedded at the time when the security module is manufactured may be used as the key bounded to the in-vehicle unit. The registration key is managed such that it is bounded to registration information (e.g., registration number) embedded simultaneously at the time of manufacture. The registration key cannot be rewritten or renewed. An update key stored in the SAM in a non-volatile manner may be used as the key bound to the in-vehicle. The update key is managed such that it is bounded to the device ID embedded simultaneously at the time of manufacture. The update key can be rewritten or renewed with the registration key.

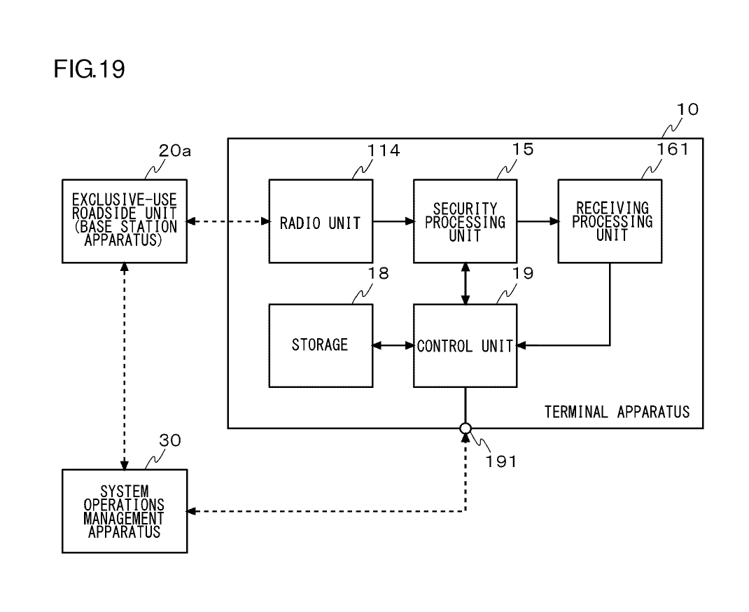

FIG. 19 is a diagram to explain the rewriting of a common key table according to a modification. The system operations management apparatus 300 is a key issuing server that issues a new key and generates a new common key table. In this modification, the system operations management apparatus 300 has a database that stores the registration numbers and the registration keys of security modules installed in all in-vehicle units shipped from a factory as well as the device IDs and the update keys thereof.

An exclusive-use roadside unit 20a is a low power base station apparatus installed in a facility that does maintenance of automobiles (hereinafter referred to as “service facility”). This unit 20a is not a roadside unit that broadcasts the real-time road information to the terminal apparatuses 10 but is a dedicated unit that wirelessly transmits the information concerning a system operation, such as a common key table, to a specific terminal apparatus 10. The exclusive-use roadside unit 20a and the system operations management apparatus 200 may connect to the Internet or may be connected to each other through a dedicated line.

The in-vehicle unit (terminal apparatus 10) of FIG. 19 depicts only a structure involving the updating of a common key table in the structure of FIG. 9. Note that the RF unit 12, the modem unit 13, and the MAC frame processing unit 14 shown in FIG. 9 are gathered together and denoted as a radio unit 114 in FIG. 19. The security processing unit 15 is configured by a security module. The storage 18 is configured by a flash memory. Or the storage 18 may be a hard disk. The receiving processing unit 161 is a functional block that processes application data of payload. The control unit 19 is a main processor that controls the entire in-vehicle unit. An external terminal 191 is a terminal used to exchange data between the system operations management apparatus 300 and the terminal apparatus 10 without involving the radio unit 114 and the exclusive-use roadside unit 20a. For example, the external terminal 191 connects to a terminal apparatus installed at a service facility through a LAN cable. This terminal apparatus connects to the system operations management apparatus 300 via the Internet. Thereby, the in-vehicle unit and the system operations management apparatus 300 can communicated with each other. The in-vehicle unit and the terminal apparatus installed at the service facility may be connected via wireless LAN or may exchange data therebetween by use of a recording medium.

In the present modification, a new common key table to be updated is transmitted from the system operations management apparatus 300 to the in-vehicle unit through two routes. A first route is a route through the external terminal 191. A second route is a route through the exclusive-use roadside unit 20a and the radio unit 144.

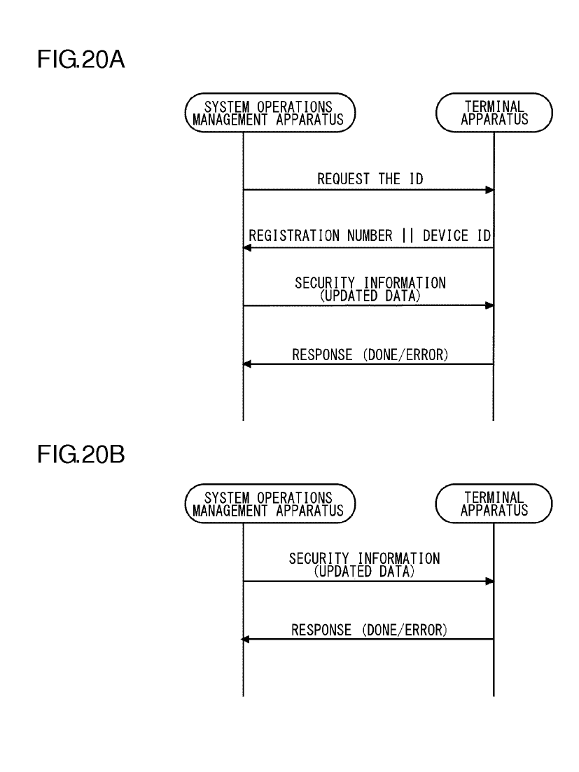

FIGS. 20A and 20B are diagrams to explain a procedure, for updating a common key table, according to a modification. FIG. 20a shows a procedure for updating a common key table through the first route. When a communication path is formed between the system operations management apparatus 300 and the terminal apparatus 10, the system operations management apparatus 300 requests the terminal apparatus 10 to send an ID. The security processing unit 15 of the terminal apparatus 10 sends concatenated data, which combines its own registration number with its own device ID, to the system operations management apparatus 300. If the device ID has not yet been set, a reserved number (e.g., a number consisting of 0s or 1s) instead of the device ID will be set.

The system operations management apparatus 300 identifies a destination terminal apparatus 10, based on the received concatenated data of the registration number and the device ID and the above-described not-shown database. If, at this time, the identified terminal apparatus 10 is one of terminal apparatuses registered in the device negative list, the system operations management apparatus 300 will not permit the updating of the common key table.

If the identified terminal apparatus 10 is one of terminal apparatuses not registered in the device negative list, the system operations management apparatus 300 will encrypt security information including update data of the common key table by use of a registration key or update key of the identified terminal apparatus 10 and then send the encrypted security information to the terminal apparatus 10. If the device ID has not yet been set to the security processing unit 15 of the terminal apparatus 10, the registration key will be used. Either the registration key or update key may be used after the device ID has been set. The security information is not stored in the management data of payload but stored in the application data thereof.

The security processing unit 15 of the terminal apparatus 10 decrypts the security information using its own registration key or update key and determines the likelihood of authenticity of payload by verifying the message authentication code (MAC). The terminal apparatus 10 responds to the system operations management apparatus 300 as to whether the decryption and the verification have been successful or not.

FIG. 20b shows a procedure for updating a common key table through the second route. If a vehicle carrying a terminal apparatus 10 is located in the neighborhood of the exclusive-use roadside unit 20a, the road-to-vehicle communication is performed between the terminal apparatus 10 and the exclusive-use roadside unit 20a. In this road-to-vehicle communication, the device ID is transmitted from the terminal apparatus 10 to the exclusive-use roadside unit 20a. Thus, the system operations management apparatus 300 can acquire the device ID of the terminal apparatus 10 via the exclusive-use roadside unit 20a without requesting the terminal apparatus 10 to send the ID as shown in FIG. 20A.

The system operations management apparatus 300 identifies a destination terminal apparatus 10, based on the received device ID and the above-described not-shown database. If, at this time, the identified terminal apparatus 10 is one of terminal apparatuses registered in the device negative list, the system operations management apparatus 300 will not permit the updating of the common key table.

If the identified terminal apparatus 10 is one of terminal apparatuses not registered in the device negative list, the system operations management apparatus 300 will encrypt security information including update data of the common key table by use of an update key of the identified terminal apparatus 10 and then send the encrypted security information to the terminal apparatus 10.

The security processing unit 15 of the terminal apparatus 10 passes the application data, in which this security information has been stored, on to the receiving processing unit 161. The receiving processing unit 161 references the registration number of a security module included in the security information stored in this application data and then determines if the security information is one addressed to this terminal apparatus 10. If the security information is one addressed to this terminal apparatus 10, the receiving processing unit 161 will pass this security information on to the control unit 19. If the security information is not the one addressed to this terminal apparatus 10, the receiving processing unit 161 will discard this security information.

The control unit 19 passes this security information on to the security processing unit 15. The security processing unit 15 decrypts this security information using its own update key and determines the likelihood of authenticity of payload by verifying the message authentication code (MAC). The terminal apparatus 10 responds to the system operations management apparatus 300 as to whether the decryption and the verification have been successful or not.

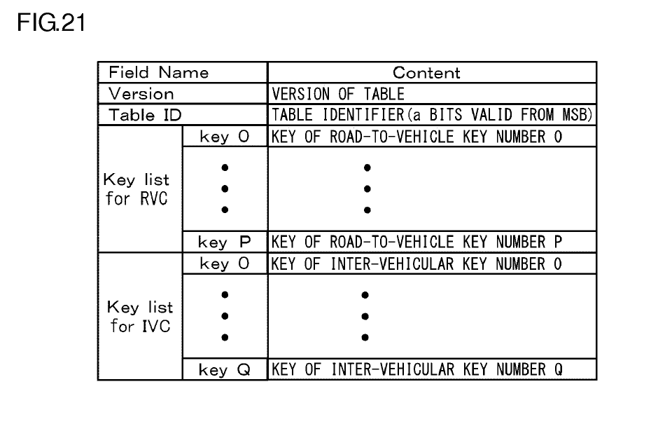

FIG. 21 shows a format of a common key table according to a modification. “Version”, “table ID”, “key list for RVC” and “key list for IVC” are provided in a “field” of the common key table. The version of a table is set to the “version”. A table identifier is set to the “table ID”. a Bits (a being a natural number) from the most significant bit (MSB) of data are set to the table identifier.

The “key list for RVC” includes “key 0” to “key P (P being a natural number)”. And a key (e.g., AES key) of a road-to-vehicle key number “0” to a key of a road-to-vehicle key number “P” are set to “key 0” to “key P”, respectively. The “key list for IVC” includes “key 0” to “key Q (Q being a natural number)”. And a key of an inter-vehicular key number “0” to a key of an inter-vehicular key number “Q” are set to “key 0” to “key Q”, respectively. On the assumption that the road-to-vehicle communication and the inter-vehicular communication use different communication schemes whose security levels differ from each other, this common key table provides the road-to-vehicle keys and the inter-vehicular keys separately. The security level of the road-to-vehicle communication is set higher than that of the inter-vehicular communication. For example, the former is used such that a key used in the road-to-vehicle communication is encrypted by combining each key with a random number, whereas the latter (key used in the inter-vehicular communication) is encrypted by using each key as it is.

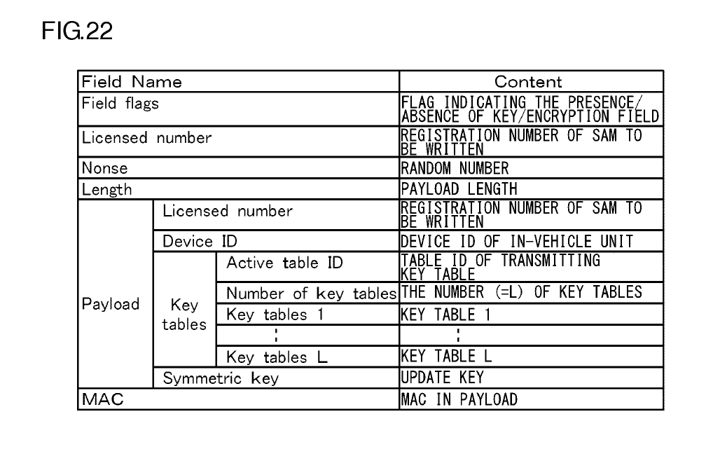

FIG. 22 shows a first format of a security frame according to a modification. The first format is a format used when a common key table is written to a security module. This first format includes “field flags”, “licensed number”, “nonce”, “length”, “payload”, and “MAC”. The payload includes “licensed number”, “device ID”, “key tables”, and “symmetric key”. The “key tables” include “active table ID”, “the number of key tables”, and “key table 1” to “key table L”.

A flag indicating whether or not a key/encryption field is present is set to the “field flags”.

In the first format, this flag is set to indicate “significant”. The security module references this flag and recognizes a data structure in the security information. The registration number of a security module to be written is set to the “licensed number”. A random number is set to the “nonce”. The data length of payload is set to the “length”. The registration number of a security module to be written is set to the “licensed number” in the “payload”. Since this “licensed number” is encrypted, another “licensed number” is also assigned to a part of the field excluding the “payload”. The device ID of the in-vehicle unit is set to the “device ID”.

The table ID of a transmitting key table is set to the “active table ID”. As will be discussed later, one of a plurality of key tables is assigned to the transmitting key table. The number of key tables (=L (L being a natural number)) included in the security information is set to “the number of key tables”. The key table 1 to the key table L are set to the “key table 1” to the “key table L”, respectively. The format shown in FIG. 21 is used for the format of each key table. An update key is set to the “symmetric key”. In order to keep the “payload” secret and authenticate it, a MAC value for the “payload” obtained by use of the registration key or update key is set to the “MAC”, and the “payload” is encrypted using the registration key or update key. The AES-CCM mode is used here as an authentication/encryption algorithm, so that the “nonce”, the “length”, the number of bytes for MAC, and the MAC value for the “payload” are set to the “MAC”. Then the “payload” and the “MAC” are encrypted.

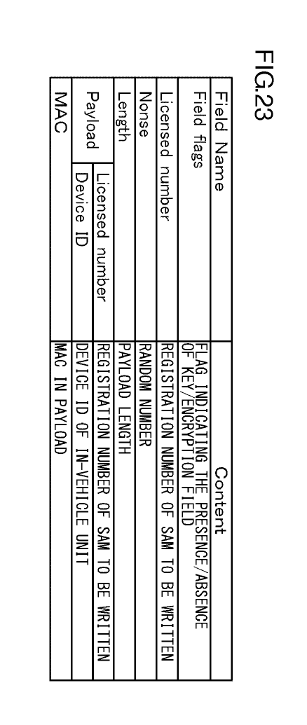

FIG. 23 shows a second format of a security frame according to a modification. The second format is a format used when a device ID is read out from the security module. The second format is constructed such that the “key tables” and the “symmetric key” are removed from the “payload” of the first format. In the second format, a flag of “field flags” is set to indicate “nonsignificant”. The other parts of the data structure of the second format are the same as the data structure of the first format and therefore the repeated description thereof is omitted here.

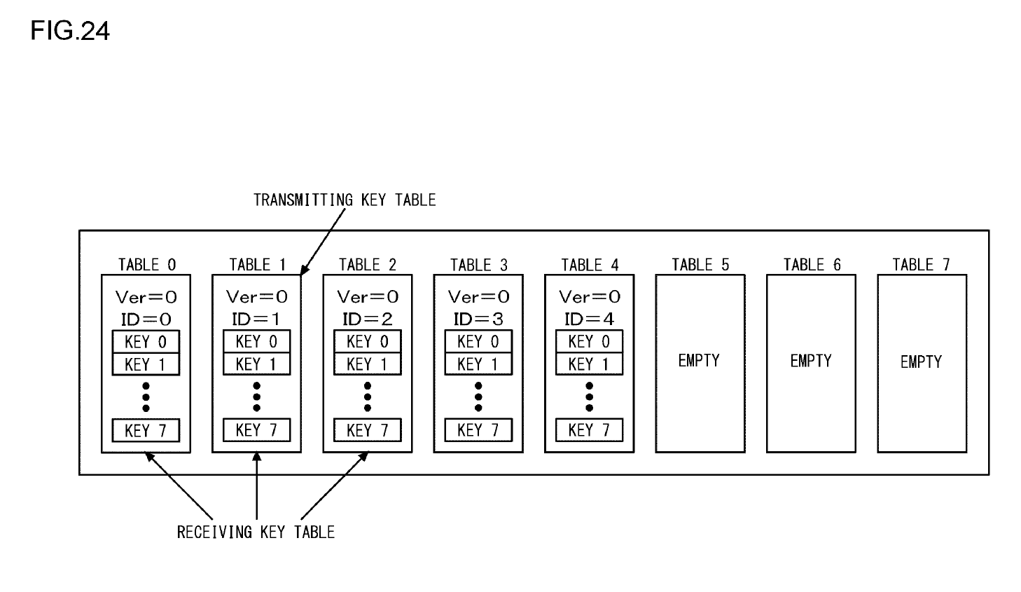

FIG. 24 is a diagram to explain a method of making use of a common key table according to a modification. The terminal apparatus 10 uses a common key table by sequentially switching a plurality of such common key tables stored therein. A description is now given of an example where the terminal apparatus 10 has a memory area (hereinafter referred to as “storage area” also), capable of storing eight common key tables, which stores five common key tables. In this modification, the number of keys stored in each common key tables is eight. Note that the number of common key tables stored in the terminal apparatus 10 and the number of keys stored in each common key table are not limited to the above-described numbers so long as it is two or more. The number of storage areas that store the common key tables is preferably at least the number of common key tables stored in the terminal apparatus 10. In other words, the numbers identified by the table IDs and the number of storage areas for the common key tables do not need to be identical to each other and may differ.

The management of common key tables is done by use of the version and the table IDs. Thus, the common key tables identified by the same table ID of different version will not be used simultaneously. Of different versions, a common key table whose version is more recent (i.e., whose version value (number) is larger) is always used. The table ID is denoted by 0 to N (N: natural number). In other words, it is set as a system of residues modulo N. In this modification, N=8. For example, the table ID of the first common table and the table ID of the ninth common table are both “0”. Every time a new common key table of the same table ID is generated, the version value (number) is incremented. Thus, the former is “0” and the latter is “1”.

Of a plurality of common key tables stored in the storage areas, a single common key table is assigned to a transmitting common key table (hereinafter referred to as “transmitting key table” also) and a plurality of common key tables are assigned to receiving common key tables (hereinafter referred to as “receiving key tables” also). The plurality of receiving key tables include a transmitting key table and includes common key tables up to a common key table of a future generation than the transmitting key table by a (a: natural number). A table ID of a future generation by n is computed such that {(the table ID of a transmitting key table+n) mod N}. The plurality of receiving key tables may include those up to a common key table of a previous generation by m (m: 0 or a natural number). Similarly, a table ID of a previous generation by m is computed such that {(the table ID of a transmitting key table−m) mod N}. The example of FIG. 24 is a case where n=m=1, the common key table whose table ID=1 is assigned to a transmitting key table, and three common key tables whose table ID=0, table ID=1 and table ID=2 are assigned respectively to the receiving key tables. If a common key table whose table ID=0 is assigned to the transmitting key table, three common key tables whose table ID=8, table ID=0 and table ID=1 will be assigned respectively to the receiving key tables. In this case, the version of the common key table whose table ID=1 is equal to or larger than, namely of the same generation as or of a future generation than, the version of the common key table whose table ID=0. The version of the common key table whose table ID=8 is, by necessity, smaller by 1 than, namely of a previous generation by 1 than, the version of the common key table whose table ID=0. If a common key table whose table ID=8 is assigned to the transmitting key table, three common key tables whose table ID=7, table ID=8 and table ID=0 will be assigned respectively to the receiving key tables. In this case, the version of the common key table whose table ID=7 is equal to or smaller by 1 than, namely of the same generation as or of a previous generation by 1 than, the version of the common key table whose table ID=8. The version of the common key table whose table ID=0 is larger than, namely of a future generation than, the version of the common key table whose table ID=8.

Even though the system operations management apparatus 300 instructs the switching of the transmitting key tables, the transmitting key tables in all terminal apparatuses 10 will not be simultaneously switched. Time lags occur in the timing with which to switch the transmitting key tables among the terminal apparatuses 10. For example, in a terminal apparatus 10 installed, in the vehicle 100, which has not been used for a long period of time, a transmitting key table of a previous generation by two or more than the most recent table may have been set to the transmitting key table. If this vehicle 100 is used, a terminal apparatus installed in another vehicle 100 will receive packet signals processed with the common key table of two or more generations past. When an encryption system is applied and implemented in practice, the security will be set higher as the range of a receiving key table gets narrower. Thus there may be many cases where the packet signals sent from valid terminal apparatuses 10 fail to be decrypted. The range of the receiving key table is set in consideration of the both demands.

If a cycle, in which the transmitting key tables are switched, is a long period of time (e.g., a few years or so), the receiving key tables may preferably be comprised of a transmitting key table and the next common key table (n=1). If the cycle, in which the transmitting key tables are switched, is a short period of time (e.g., equal to or less than a year), the receiving key tables may preferably be comprised of a transmitting key table, the next common key table (n=1) and the subsequent common key tables (n>1). Many common key tables are preferably incorporated into the receiving key tables such that the shorter the switching period is, the larger the “n” will be. If the switching period is short, the variation in the transmitting key table gets larger among a plurality of terminal apparatuses 10. In contrast thereto, an increase in the number of common key tables incorporated into the receiving key tables reduces the mismatch of the transmitting key tables. Note that 1 or 0 is suitable for m.

A plurality of common key tables are encrypted and then stored in the storage 18. In the example shown in FIG. 24, five common key tables are stored. When a terminal apparatus 10 is activated, the security processing unit 15 reads out the encrypted common key tables stored in the storage 18. The security processing unit 15 decrypts the encrypted common key tables and then stores the decrypted common key tables in work areas configured by RAM (not shown). The common key tables held in these work areas are common key tables assigned to the transmitting key table and the receiving key tables. In the example shown in FIG. 24, three common key tables whose table ID=0, table ID=1 and table ID=2 are held respectively in the work areas.

When the terminal apparatus 10 is activated, the security processing unit 15 reads out common key tables from the storage 18 and, at the same time, generates a key negative map. Registered in this key negative map are keys stored in common key tables excluding the common key tables assigned to the transmitting key table and the receiving key tables. For example, the key negative map is generated in a bit map format. The security processing unit 15 stores the thus generated key negative map in the work area as well. When receiving messages in the road-to-vehicle communication or the inter-vehicular communication, the security processing unit 15 references the key negative map to determine if any unusable key is in use. If a key registered in the key negative map is in use, it will be determined that error has occurred. When transmitting message from the terminal apparatus 10, the security processing unit 15 uses any one of the keys included in the transmitting key tables and therefore there is no need to determine if the key in use is registered in the key negative map.

By employing the present modifications as described above, the updating common key table is encrypted using the registration key or update key of the security module and then the encrypted update common key table is transmitted to the in-vehicle unit, thereby simplifying the updating process of common key tables. Also, the updating common key table is not stored in the management data of the payload but stored in the application data, so that an update system excelling in flexibility and extendability can be constructed.

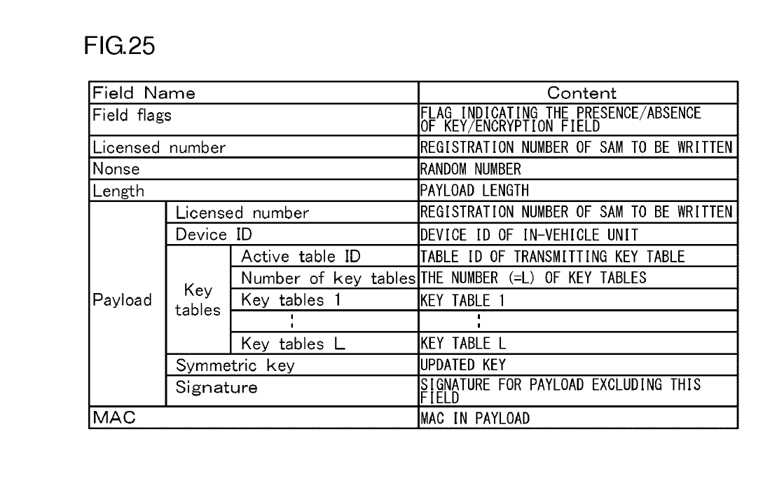

FIG. 25 shows a modification of the first format of the security frame shown in FIG. 22. “Signature” is added to the tail of “payload” of FIG. 22. A signature for the payload excluding this field is set to the “signature”. Upon receiving this security frame, the security module decrypts and verifies the frame and then verifies the signature. An authentication key used to verify the signature is stored beforehand in the security module. By verifying the signature, whether or not the common key tables are sent from a valid source can be verified, so that the security level of the system as a whole can be enhanced. In the security frame of FIG. 25, too, the security frame of FIG. 23 is used as it is.

In the processes, for updating the common key tables, according to the exemplary embodiments as shown in FIG. 13 and FIG. 14, the registration key or update key according to the modifications may be used in place of the update master key. That is, the registration key or update key is used to encrypt and decrypt the table updating key sent separately from the common key table. Since the registration key or update key differs for each terminal apparatus, the security level can be enhanced than when a common update master key is used and shared by all of the terminal apparatuses.

What is claimed is:

1. A communication apparatus comprising:
a storage configured to store a common key table, its own identification information, and an update key associated with the identification information, the common key table containing a plurality of kinds of common keys usable for a communication with another communication apparatus within a single system;
a transmitter configured to transmit the identification information to a system management apparatus for managing the common key table, used in the system, the identification information on the communication apparatus within the system, and the update key associated with the identification information thereon;
an acquiring unit configured to acquire, from the system management apparatus that has received the identification information, a common key table for use in update (updating common key table) encrypted using the update key associated with the identification information; and
a decryption unit configured to decrypt the encrypted updating common key table by use of the update key stored in the storage.

2. A communication apparatus comprising:
a security processing unit configured to decrypt received data;
a storage configured to store a common key table, registration information on the security processing unit, and a registration key associated with the registration information, the common key table containing a plurality of kinds of common keys usable for a communication with another communication apparatus within a single system;
a transmitter configured to transmit the registration information to a system management apparatus for managing the common key table used within the system, the registration information on the security processing of the communication system within the system, and the registration key associated with the registration information; and
an acquiring unit configured to acquire, from the system management apparatus that has received the registration information, a common key table for use in update (updating common key table) encrypted using the registration key associated with the registration information,
wherein the security processing unit decrypts the encrypted updating common table by use of the registration key stored in the storage.

3. A communication apparatus comprising:
a storage configured to store a common key table, which contains a plurality of kinds of common keys usable for a communication with another communication apparatus within a single system, and an update master key commonly used in the system;
an acquiring unit configured to acquire a table updating key, used to encrypt a common key table for use in update (updating common key table), and the updating common key table encrypted using the table updating key, which are transmitted from a system management apparatus for managing the common key table, and configured to acquire identification information, on an communication apparatus, transmitted from said communication apparatus to be updated; and
an encryption unit configured to encrypt the table updating key using the update master key and the identification information on said communication apparatus; and
a broadcasting unit configured to broadcast the table updating key encrypted by the encryption unit and the encrypted updating common key table.

4. A communication apparatus according to claim 3, wherein the acquiring unit acquires from the system management apparatus a list of communication apparatuses for which the common key table is not to be updated, and
wherein, when identification information on communication apparatuses included in the list is acquired by the acquiring unit, the broadcasting unit stops broadcasting the table updating key encrypted using said identification information and the update master key.
